(19) United States
(12) Patent Application Publication
(10) Pub. No.: US 2025/0382518 A1
(43) Pub. Date: Dec. 18, 2025

(54) COKE PROPPANT PARTICLES COATED WITH FRICTION REDUCER, METHODS FOR MAKING SUCH PARTICLES, AND HYDRAULIC FRACTURING PROCESSES UTILIZING SUCH PARTICLES

(71) Applicant: ExxonMobil Technology and Engineering Company, Spring, TX (US)

(72) Inventors: Lee J. HALL, The Woodlands, TX (US); Xiao JIN, Kingwood, TX (US); P. Matthew SPIECKER, Manvel, TX (US)

(21) Appl. No.: 18/743,970

(22) Filed: Jun. 14, 2024

(51) Int. Cl. C09K 8/80; C09K 8/68; E21B 43/267

(52) U.S. Cl. CPC C09K 8/805; C09K 8/68; E21B 43/267; C09K 2208/28

(57) ABSTRACT

Friction reducer-coated coke proppant particles comprise a friction reducer coating deposited on and/or over outer surfaces of coke proppant particles, where the friction reducer coating is provided with a thickness of 1 μm to 50 μm. A fracturing fluid comprises (among other potential components) a carrier fluid and such friction reducer-coated coke proppant particles. A method for making such friction reducer-coated coke proppant particles comprises depositing a friction reducer on and/or over an outer surface of coke proppant particles, where the weight percentage of the friction reducer used during the deposition process is from 0.1 wt % to 2.3 wt %, based on the total weight of the friction reducer and the coke proppant particles.

### FIELD

This disclosure relates generally to the field of hydraulic fracturing operations and the fracturing fluids and proppant particles employed therein. More specifically, this disclosure relates to coke proppant particles that are coated with friction reducer, methods for making such friction reducer-coated coke proppant particles, and hydraulic fracturing processes utilizing such friction reducer-coated coke proppant particles.

### BACKGROUND

This section is intended to introduce various aspects of the art, which may be associated with aspects and embodiments of the present disclosure. This discussion is believed to assist in providing a framework to facilitate a better understanding of particular aspects and embodiments of the present disclosure. Accordingly, it should be understood that this section should be read in this light, and not necessarily as admissions of prior art.

A wellbore can be drilled into a subterranean formation to promote the removal (or production) of a resource, such as hydrocarbon fluids, coal, minerals, water, or the like. In many cases, the subterranean formation needs to be stimulated in some manner to promote the removal of the resource. Stimulation can include any operation performed upon the matrix of a subterranean formation to improve fluid conductivity therethrough, including hydraulic fracturing, which is commonly used for unconventional reservoirs.

Hydraulic fracturing typically involves the pumping of large quantities of fracturing fluid into a subterranean formation (e.g., a low-permeability formation) under high hydraulic pressure to promote the formation of one or more fractures within the matrix of the formation and to create high-conductivity flow paths. Primary fractures extending from the wellbore and, in some instances, secondary fractures extending from the primary fractures are formed during a fracturing operation. These fractures may be vertical, horizontal, or a combination of directions forming a tortuous path.

Proppant particles are often included in the fracturing fluid. Once the fracturing fluid has been pumped into the subterranean formation, it is desired that such proppant particles could be transported into the fractures and settle therein. Upon pressure release, the proppant particles remaining in the fractures keep the fractures open by preventing them from collapsing, facilitating the flow of the desired resource from the fractured formations into the wellbore through the propped fractures due to its improved permeability and conductivity when compared to that of the unconventional formation matrix. The performance of the proppant can affect the recovery of the intended resource significantly.

Sand has been traditionally used as a proppant in hydraulic fracturing for the production of hydrocarbon fluids from unconventional formations due to its shape, mechanical properties, and easy availability with limited processing. Various other types of proppants have been proposed and available to substitute sand, such as ceramics and polymers. Nonetheless, all these existing proppants suffer from one of more drawbacks, such as high cost and limited hydrocarbon recovery rate. Thus, there is a genuine need of high-performance proppants, hydraulic fracturing fluids, and hydraulic fracturing methods in the industry. This disclosure satisfies these and other needs.

### SUMMARY

An aspect of the present disclosure provides friction reducer-coated coke proppant particles. The friction reducer-coated coke proppant particles may include a friction reducer coating deposited on and/or over outer surfaces of coke proppant particles, where the friction reducer coating may be present with a thickness of 1 μm to 50 μm.

Another aspect of the present disclosure provides a fracturing fluid. The fracturing fluid may include (among other potential components) a carrier fluid and friction reducer-coated coke proppant particles.

Another aspect of the present disclosure provides a method for making friction reducer-coated coke proppant particles. The method may include depositing a friction reducer on and/or over outer surfaces of coke proppant particles to obtain friction reducer-coated coke proppant particles; where the weight percentage of the friction reducer used during the deposition process may be from 0.1 wt % to 2.3 wt %, based on the total weight of the friction reducer and the coke proppant particles, and where the thickness of the resulting friction reducer coating may be from 1 micrometer (μm) to 50 μm.

Another aspect of the present disclosure provides a method for making a fracturing fluid. The method may include: providing friction reducer-coated coke proppant particles and mixing the friction reducer-coated coke proppant particles with a carrier fluid and optionally additives.

Another aspect of the present disclosure provides a method for hydraulic fracturing a subterranean formation. The method may include introducing the fracturing fluid described above into the subterranean formation.

These and other features and attributes of the disclosed aspects and embodiments of the present disclosure and their advantageous applications and/or uses will be apparent from the detailed description that follows.

### BRIEF DESCRIPTION OF THE DRAWINGS

To assist those of ordinary skill in the relevant art in making and using the subject matter described herein, reference is made to the appended drawings, where:

FIG. 1 is a graph comparing the apparent densities of petroleum coke particles within a petroleum coke sample to the apparent densities of sand particles within a sand sample;

FIG. 2 is a graph showing cumulative density functions for fluid coke particles within two fluid coke samples;

FIG. 3 is a graph showing particle size distributions for fluid coke particles within two fluid coke samples;

FIG. 4 is a bar graph showing the terminal settling velocities in recycled water for sand particles within a 40/70-mesh sand sample, sand particles within a 100-mesh sand sample, and fluid coke particles within a 100-mesh fluid coke sample;

FIG. 5 is a bar graph comparing the crush strengths of sand particles within a regional sand sample to the crush strengths of fluid coke particles within a fluid coke sample;

FIG. 6 is a graph showing settling velocity as a function of particle size for several different mesh sizes of sand and petroleum coke;

FIG. 7 is a graph showing particle size distributions for four unsieved fluid coke samples;

FIG. 8 is a bar graph comparing the crush strengths of different types of proppant;

FIG. 9 is a process flow diagram of an exemplary method for making coke proppant particles with a friction reducer coating; and

FIG. 10 is a process flow diagram of an exemplary hydraulically fracturing process utilizing friction reducer-coated coke proppant particles.

It should be noted that the figures are merely examples of the present disclosure and are not intended to impose limitations on the scope of the present disclosure. Further, the figures are generally not drawn to scale, but are drafted for purposes of convenience and clarity in illustrating various aspects of the present disclosure.

### DETAILED DESCRIPTION

In the following detailed description section, the specific examples of the present disclosure are described in connection with preferred aspects and embodiments. However, to the extent that the following description is specific to one or more aspects or embodiments of the present disclosure, this is intended to be for exemplary purposes only and simply provides a description of such aspect(s) or embodiment(s). Accordingly, the present disclosure is not limited to the specific aspects and embodiments described below, but rather, includes all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition those skilled in the art have given that term as reflected in at least one printed publication or issued patent. Further, the present disclosure is not limited by the usage of the terms shown below, as all equivalents, synonyms, new developments, and terms or processes that serve the same or a similar purpose are considered to be within the scope of the present claims.

As used herein, the singular forms “a,” “an,” and “the” mean one or more when applied to any embodiment described herein. The use of “a,” “an,” and/or “the” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., ±1%, ±5%, ±10%, ±15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

As used herein, the term “apparent density,” with reference to the density of proppant particles, refers to the density of the individual particles themselves, which may be expressed in grams per cubic centimeter (g/cm³ or g/cc). The apparent density values provided herein are based on the American Petroleum Institute's Recommended Practice 19C (hereinafter “API RP-19C”) standard, entitled “Measurement of Properties of Proppants Used in Hydraulic Fracturing and Gravel-packing Operations” (First Ed. May 2008, Reaffirmed June 2016).

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the term “blast furnace coke” refers to any coal-derived coke suitable for use in a blast furnace for making steel.

As used herein, the term “crush strength,” when used with reference to proppant particles, refers to the uniaxial stress (compressive) load that the proppant particles can withstand prior to crushing (e.g., breaking or cracking). The crush strength values of the present disclosure are based on API RP-19C.

As used herein, the terms “example,” exemplary,” and “embodiment,” when used with reference to one or more components, features, structures, or methods according to the present disclosure, are intended to convey that the described component, feature, structure, or method is an illustrative, non-exclusive example of components, features, structures, or methods according to the present disclosure. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present disclosure.

As used herein, the term “flexicoke” refers to the solid concentrated carbon material produced via the FLEXICOKING™ process, which is a thermal cracking process utilizing fluidized solids and gasification for the conversion of heavy, low-grade hydrocarbon feeds into lighter hydrocarbon products (e.g., upgraded, more valuable hydrocarbons). Briefly, the FLEXICOKING™ process integrates a cracking reactor, a heater, and a gasifier into a common fluidized-solids (coke) circulating system. A feed stream (of residua) is fed into a fluidized bed, along with a stream of hot recirculating material to the reactor. From the reactor, a stream containing coke is circulated to the heater vessel, where it is heated. The hot coke stream is sent from the heater to the gasifier, where it reacts with air and steam. The gasifier product gas, referred to as coke gas, containing entrained coke particles, is returned to the heater and cooled by cold coke from the reactor to provide a portion of the reactor heat requirement, which is typically in a range from around 496° C. to around 538° C. A return stream of coke sent from the gasifier to the heater provides the remainder of the heat requirement. The coke meeting the heat requirement is then circulated to the reactor, and the feed stream is thermally cracked to produce light hydrocarbon liquids that are removed from the reactor and recovered using conventional fractionating equipment. Fluid coke is formed from the thermal cracking process and settles (deposits) onto the “seed” fluidized bed coke already present in the reactor. The resultant at least partially gasified coke is flexicoke. In some instances, the coke from the thermal cracking process deposits in a pattern that appears ring-like atop the surface of the seed coke. Flexicoke is continuously withdrawn from the system during normal FLEXICOKING™ processing (e.g., from the reactor or after it is streamed to the heater via an elutriator) to ensure that the system maintains particles of coke in a fluidizable particle size range. Accordingly, flexicoke is a readily available byproduct of the FLEXICOKING™ process.

Relatedly, the terms “wet flexicoke fines” and “dry flexicoke fines” refer to two byproducts of the FLEXICOKING™ process. Such byproducts are collected as particles that were not recovered in the secondary cyclones of the heater. More specifically, the particles are collected first in the tertiary cyclone as dry flexicoke fines, and the smaller particles that travel past the tertiary cyclone are then recovered in the venturi scrubber as wet flexicoke fines.

As used herein, the term “fluid coke” refers to the solid concentrated carbon material remaining from fluid coking. The term “fluid coking” refers to a thermal cracking process utilizing fluidized solids for the conversion of heavy, low-grade hydrocarbon feeds into lighter products (e.g., upgraded hydrocarbons), producing fluid coke as a byproduct. The fluid coking process differs from the FLEXICOKING™ process that produces the flexicoke in that the fluid coking process does not include a gasifier.

The term “fracture” (or “hydraulic fracture”) refers to a crack or surface of breakage within a subterranean formation, that can be induced by an applied pressure or stress.

As used herein, the term “friction reducer” refers to any chemical agent that, if added into a fracturing fluid free of the agent, reduces turbulence in the resultant fluid and reduces fluid drag where the resultant fluid is in contact with solid surfaces and moves along the flow path, compared to the fracturing fluid free of the agent. The term “high-viscosity friction reducer (HVFR)” refers to a friction reducer that, if added into a fracturing fluid free of the agent, also results in a higher viscosity of the resultant fluid compared to the fracturing fluid free of the agent.

As used herein, the term “hydraulic conductivity” refers to the ability of a fluid within a subterranean formation to pass through a fracture including proppant at various stress (or pressure) levels, which is based, at least in part, on the permeability of the proppant deposited within the hydraulic fractures. The hydraulic conductivity values provided herein are based on the American Petroleum Institute's Recommended Practice 19D (API RP-19D) standard, entitled “Measuring the Long-Term Conductivity of Proppants” (First Ed. May 2008, Reaffirmed May 2015).

As used herein, the term “metallurgical coke” refers to a type of coal-derived coke that is produced by heating coal, which causes fixed carbon to fuse to inherent ash and drives off a large percentage of the volatile matter. The resulting metallurgical coke particles include a range of different sizes, with the smallest particles being a fine powder (sometimes referred to as “coke breeze”).

The term “particle size(s),” when used herein with reference to a type of particles,” refers to the diameter(s) of such particle(s). The term “particle size distribution,” when used herein with reference to a type or a collection of particles, refers to the range of diameters for such particles, typically from the minimal to the maximal. The terms “median particle size” and “D50” when used herein with reference to a type or a collection of particles, interchangeably means the median of the particle sizes for the type or collection of particles.

The term “petroleum coke” refers to a final carbon-rich solid material that is derived from oil refining. More specifically, petroleum coke is the carbonization product of high-boiling hydrocarbon fractions that are obtained as a result of petroleum processing operations. Petroleum coke is produced within a coking unit via a thermal cracking process in which long-chain hydrocarbons are split into shorter-chain hydrocarbons. As described herein, there are at least three main types of petroleum coke: delayed coke, fluid coke, and flexicoke. Each type of petroleum coke is produced using a different coking process; however, all three coking processes have the common objective of maximizing the yield of distillate products within a refinery by rejecting large quantities of carbon in the residue as petroleum coke.

The term “coal-derived coke” means any coke prepared from coal by, e.g., thermal treatment.

As used herein, the terms “proppant” and “proppant particle” refer to a solid material capable of maintaining open an induced fracture during and following a hydraulic fracturing treatment. The term “proppant pack” refers to a collection of proppant particles.

The terms “coke proppant” and “coke proppant particles” refer to a proppant based on or derived from a solid carbonaceous material produced from treating a carbon-containing material (e.g., oil (e.g., crude oil, vacuum pipestill, and the like), coal, and hydrocarbons) at an elevated temperature in an oxygen deficient environment. The elevated temperature can be at least 200, 250, 300, 350; 400, 450, 500, 600, 700, 800, 900, or even 1000° C. The carbonaceous material comprises the carbon element, and optionally additional elements including but not limited to hydrogen, sulfur, vanadium, iron, and the like. The carbonaceous material preferably comprises the carbon element at a concentration of ≥50 wt %, e.g., from 50, 55, 60, 65, 70, wt %, to 75, 80, 85, 90, 95 wt %, to 96, 97, 98, 99 wt %, or even 100 wt %, based on the total weight of all elements in the carbonaceous material. The carbonaceous material preferably comprises the carbon element and hydrogen element at a combined concentration of ≥55 wt %, e.g., from 55, 60, 65, 70, wt %, to 75, 80, 85, 90, 95 wt %, to 96, 97, 98, 99 wt %, or even 100 wt %, based on the total weight of all elements in the carbonaceous material.

The term “non-coke proppant” means any proppant that does not comprise coke proppant particles. Examples of non-coke proppant include sand, ceramic proppants, glass proppants, and polymer proppants.

The term “lightweight proppant (LWP)” refers to proppants having an apparent density within a range of from around 1.2 g/cm³ to around 2.2 g/cm³ (e.g., from around 1.2, 1.3, 1.4, 1.5, 1.6 g/cm³ to around 1.7, 1.8, 1.9, 2.0, 2.1, 2.2 g/cm³), while the term “ultra-lightweight proppant (ULWP)” refers to proppants having an apparent density within a range from around 0.5 g/cm³ to around 1.2 g/cm³ (e.g., from around 0.5, 0.6, 0.7, 0.8 g/cm³ to around 0.9, 1.0, 1.1, 1.2 g/cm³). A coke proppant may or may not be an LWP. The term “non-LWP proppant” refers to proppants having apparent density higher than 2.2 g/cm³ (e.g., from around 2.3, 2.4, 2.5 to around 2.6, 2.8, 3.0, to 3.2, 3.4, 3.5 g/cm³.) A non-coke proppant may or may not be a non-LWP.

The term “microproppant coke particles” means a collection of coke proppant particles having particle sizes of at most 105 μm, but potentially within a range from around 0.0001 μm to 105 μm (e.g., from around 0.0001, 0.001, 0.01, 0.1 μm to 0.5, 1.0, 2.0, 5.0, 8.0 10 μm, to 15, 20, 25, 30, 35, 40, 45 μm, to 50, 53, 55, 60, 63, 65 μm, to 74, 75, 80, 85, 88, 90, 95, 100, 105 μm).

The term “petroleum coke proppant particles” means a collection of coke proppant particles that are derived from a petroleum coke source material. The term “petroleum coke fines” means a collection of microproppant coke particles that are derived from a petroleum source material.

As used herein, the term “pyrolysis coke” refers to a type of coke that is generated via hydrocarbon pyrolysis at temperatures higher than the coking processes for making petroleum coke.

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

The term “substantially free” or “essentially free” when used with reference to a component of a composition, interchangeably means that the composition comprises the component at a concentration of ≤10 wt %, ≤5 wt %, ≤3 wt %, ≤1 wt %, or 0 wt %, based on the total weight of the composition.

As used herein, the term “thermally post-treated coke” refers to petroleum coke that has been heated to temperatures in a range from around 400° C. to 1200° C. (e.g., from around 400, 500, 600° C., to 700, 800, 900° C., to 1000, 1100, 1200° C.) for a predetermined duration that is in a range from around 1 minute to around 24 hours (e.g., from 5, 10, 15, 20, 25, 30 minutes to 40, 50, 60 minutes, to 2, 3, 4, 5 hours, to 6, 7, 8, 9, 10 hours, to 11, 12, 13, 14, 15 hours, to 16, 17, 18, 19, 20 hours).

The term “wellbore” refers to a borehole drilled into a subterranean formation. The borehole may include vertical, deviated, highly deviated, and/or lateral sections. The term “wellbore” also includes the downhole equipment associated with the borehole, such as the casing strings, production tubing, gas lift valves, and other subsurface equipment. Relatedly, the term “hydrocarbon well” (or simply “well”) includes the wellbore in addition to the wellhead and other associated surface equipment.

Certain embodiments and features are described herein using a set of numerical upper limits and a set of numerical lower limits. It should be appreciated that ranges from any lower limit to any upper limit are contemplated unless otherwise indicated. All numerical values are “about”, “around,” or “approximately” the indicated value, and account for experimental errors and variations that would be expected by a person having ordinary skill in the art.

During the drilling of a hydrocarbon well, a wellbore is formed within a subterranean formation using a drill bit that may be advanced at the lower end of a drill string until it reaches a predetermined location in the subsurface. The drill string and bit may then be removed, and the wellbore may be lined with steel tubulars, commonly referred to as casing strings. An annulus may thus be formed between the casing strings and the surrounding subterranean formation. A cementing operation may be conducted to fill the annulus with columns of cement. The combination of the casing strings and the cement strengthens the wellbore and isolates or impedes fluid flow and pressure transmissibility along the annulus.

It is common to place several casing strings having progressively-smaller outer diameters into the wellbore. The first casing string may be referred to as the “surface casing string.” The surface casing string serves to isolate and protect the shallower, freshwater-bearing aquifers from contamination by any other wellbore fluids. Accordingly, this casing string may be cemented entirely back to the surface.

A process of drilling and then cementing progressively-smaller casing strings may be repeated several times below the surface casing string until the hydrocarbon well has reached total depth. The final casing string, referred to as the “production casing string,” may extend through a hydrocarbon-bearing interval (referred to as a “reservoir”) in the subterranean formation. In some instances, the production casing string is a production liner, that is, a casing string that is not tied back to the surface. The production casing string may also be cemented into place. In some completions, the production casing string has swell packers or plugs spaced across selected productive intervals. This creates compartments between the packers for isolation of stages and specific stimulation treatments. In this instance, the annulus may simply be packed with sand.

As part of the completion process, a section of the wellbore (referred to as a “stage”) may be isolated through the setting of a packer or plug. The production casing string may then be perforated at one or more desired intervals uphole of the plug, meaning that clusters of perforations are created through the production casing string and the cement column surrounding the production casing string using a perforating gun. In operation, the perforating gun may form one perforation cluster by shooting a number of perforations in close proximity, such as, for example, 12 to 18 perforations at one time, over a 1 foot (ft) (0.3 meter (m)) to 3 ft (3 m) region, for example, with each perforation potentially being approximately 0.3 inches (in) (0.8 centimeters (cm)) to 0.5 in (1.3 cm) in diameter, for example. The perforating gun may then be moved uphole around 10 ft (3 m) to 100 ft (30 m), for example, and a second perforating gun may be used to form a second perforation cluster. This process of forming perforation clusters may be repeated to create additional perforation clusters within each stage of the hydrocarbon well. The resulting perforation clusters may allow hydrocarbon fluids from the surrounding subterranean formation to flow into the hydrocarbon well. Note that in some instances, however, the production casing string is instead provided as a sliding sleeve tubular or other type of casing string with pre-formed perforation clusters. In such instances, the preformed perforations may be initially closed but can be opened through various forms of actuation to control fluid flow through the perforations.

After the perforation process is complete, the subterranean formation may be hydraulically fractured at each stage of the wellbore to increase the productivity of the subterranean formation. Hydraulic fracturing consists of injecting a volume of fracturing fluid through the created perforations and into the surrounding subterranean formation at such high pressures and rates that the subsurface rock in proximity to the perforations cracks open and resulting hydraulic fractures extend outwardly into the subterranean formation in proportion to the injected fluid volume. Ideally, a separate hydraulic fracture emanates outwardly from each perforation cluster, forming a set of hydraulic fractures, commonly referred to as a “fracture network.” Ideally, this fracture network includes a sequence of parallel fracture planes, thereby creating as much fracturing of the subsurface rock as possible. Near the wellbore, a complex topology of hydraulic fractures may sometimes result from the breakdown of perforations within each perforation cluster, but it is common to assume that these hydraulic fractures ultimately link up to form a single dominant fracture plane that is hydraulically connected to the wellbore. In operation, to create the hydraulic fracture, the injection pressure of the fracturing fluid must exceed the hydraulic pressure in the subterranean formation plus the strength of the rock, and often even exceeds the lithostatic pressure in the subterranean formation.

Hydraulic fracturing is used most extensively for increasing the productivity of “unconventional” (or “tight”) subterranean formations, which are subterranean formations with very low permeability that typically do not produce economically without hydraulic fracturing. Examples of unconventional subterranean formations include tight sandstone formations, tight carbonate formations, shale gas formations, coal bed methane formations, and tight oil formations. During the hydraulic fracturing of such subterranean formations, the pump rate (or injection rate) of the fracturing fluid may be increased until it reaches a maximum pump rate of around 20 barrels per minute (bbl/min) to around 150 bbl/min (e.g., 20, 60, 90 bbl/min, to 120, 150 bbl/min). In operation, around 5,000 barrels to around 15,000 barrels (e.g., 5,000, 6,000, 7,000, 8,000 barrels, to 9,000, 10,000, 11,000, 12,000 barrels, to 13,000, 14,000, 15,000 barrels) of fracturing fluid may be injected for each stage of the hydrocarbon well, for example.

In operation, a small portion (e.g., often around 5% to around 10%) of the fracturing fluid may be pumped into the wellbore during a pad phase of the hydraulic fracturing operation for each stage. The pad phase is designed to initiate hydraulic fractures and grow the hydraulic fractures to a certain size and volume to accommodate the injection of a proppant, such as sand, crushed granite, ceramic beads, polymer particulates, or other granular materials (which are generally referred to herein as “non-coke proppants”). The remaining portion of the fracturing fluid may then be mixed with the proppant and pumped into the wellbore and through the perforations into the stimulated reservoir volume (SRV). The proppant serves to hold the hydraulic fractures open after the hydraulic pressure is released. Ideally, the resulting hydraulic fractures grow to be hundreds of feet radially from the wellbore into the subterranean formation. In the case of unconventional subterranean formations, the combination of hydraulic fractures and injected proppant substantially increases the flow capacity of the treated formation.

This application of hydraulic fracturing is a routine part of petroleum industry operations as applied to individual subterranean formations. Such subterranean formations may represent hundreds of feet of gross, vertical thickness of subterranean formation. More recently, hydrocarbon wells are being completed through formations laterally, with the lateral sections often extending at least 5,000 feet (1,524 meters), in which case the hydrocarbon well may be referred to as an “extended-reach lateral well,” or, in some cases, at least 15,000 feet (4,572 meters), in which case the hydrocarbon well may be referred to as an “ultra-extended-reach lateral well.”

When there are multiple-layered or very thick formations to be hydraulically fractured, or where an extended-reach or ultra-extended-reach lateral well is being completed, then more complex treatment techniques may be utilized to obtain treatment of the entire target area. Therefore, the operating company may isolate the various stages (as described above) to ensure that each separate stage is not only perforated, but also adequately fractured and treated. In this way, the operator may be sure that fracturing fluid is being injected through each perforation cluster and into each stage of interest to effectively increase the flow capacity at each desired depth and lateral location.

Treatment of a stage of interest may involve isolating the stage from all stages that have already been treated. This may involve the use of so-called diversion methods, in which injected fracturing fluid is directed towards one selected stage of interest while being diverted from other stages. In many cases, frac plugs are set between stages and are used to prevent injected fluid from entering stages that have already been fractured and propped.

This hydraulic fracturing process may be repeated for every stage in the hydrocarbon well. In the case of wells including lateral sections, the first stage is typically located near the end (or “toe”) of the lateral section, and the last stage is typically located near the beginning (or “heel”) of the lateral section. For extended-reach lateral wells, there may be around 20 to around 50 individual stages, for example. For ultra-extended-reach lateral wells, there may be more than 100 stages, for example.

After the hydraulic fracturing process is complete, the frac plugs (and/or other diversion materials) may be drilled out of the hydrocarbon well. The hydrocarbon well may then be brought on production, meaning that it may be used to recover hydrocarbon fluids from the subterranean formation. In operation, the pressure differential between the formation and the hydrocarbon well may be used to force hydrocarbon fluids to flow through the hydraulic fractures within the formation and into the production casing string via the corresponding perforation clusters. The hydrocarbon fluids then flow up the hydrocarbon well to the surface.

In operation, the success of the hydraulic fracturing process has a direct impact on the ultimate production performance of the hydrocarbon well. Specifically, the numbers, sizes, compliances, and locations of the hydraulic fractures corresponding to the perforation clusters within each stage of the hydrocarbon well directly impact the amount of hydrocarbon fluids that are able to mobilize and flow into the hydrocarbon well. However, the success of the hydraulic fracturing process is limited by the ability of the fracturing fluid to penetrate deeply into the formation, thus enabling the proppant to deposit within extended regions of the hydraulic fractures.

According to conventional techniques, sand is often used as the proppant within the fracturing fluid. However, sand tends to settle out of the fracturing fluid relatively quickly, thus limiting the effectiveness of the hydraulic fracturing operation. To mitigate the low transport capacity of sand, highly-viscous carrier fluids are often utilized along with sand to enable the sand to stay suspended within the fracturing fluid for longer periods of time and, therefore, to penetrate deeper into the formation. Slickwater includes added friction reducers, such as high-molecular-weight polyacrylamides, for example, that are designed to reduce the turbulent friction in the wellbore and through the fracture to allow higher injection rates with lower pumping pressures. However, even with the utilization of such friction reducers, sand still tends to settle out of the fracturing fluid relatively quickly.

Therefore, the present disclosure alleviates the foregoing difficulty and provides related advantages as well. Specifically, the present disclosure provides friction reducer-coated coke proppant particles that exhibit improved transport and suspension properties as compared to non-coke proppants, such as sand. The present disclosure also provides methods for making such friction reducer-coated coke proppant particles, as well as processes for utilizing such friction reducer-coated coke proppant particles during hydraulic fracturing operations.

More specifically, according to the present disclosure, low-density coke proppant particles, which already have improved transport properties as compared to relatively high-density sand particles, are coated with a friction reducer that further enhances the transport properties of the coke proppant particles. Any suitable type(s) of friction reducers may be used, alone or in any suitable combination. The friction reducer may form a continuous or discontinuous layer on or over the outer surface of a given substrate coke proppant particle, with or without any intermediate layer of materials such as a binder between the outer surface of the substrate coke proppant particle and the friction reducer coating. In various embodiments, the friction reducer coating comprises a polymer, such as a polymer (preferably a high molecular weight polymer) comprising structural units derived from an acrylamide (“acrylamide structure units”), which can have a density that approximates the density of the surrounding carrier fluid. The polymer may be a copolymer comprising structural units derived from acrylamide and additional structural units derived from acrylic acid (“acrylic acid structural units”). In a preferred embodiment, the polymer is a copolymer comprising structural units derived from acrylamide, acrylic acid, and structural units derived from acrylamido-2-methylpropane sulfonic acid (“AMPS”) (“AMPS structural units”). In another preferred embodiment, the polymer is a copolymer comprising structural units derived from acrylamide, acrylic acid, and structural units derived from trimethylamino ethyl acrylate (“TMAEA”) (“TMAEA structural units”). Exemplary acrylamide structural units, acrylic acid structural units, AMPS structural units, and TMAEA structural units are shown in formula F-1, F-2, F-3, and F-4 below:

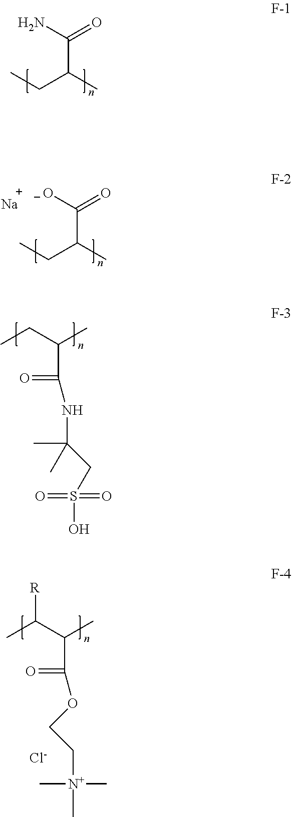

In various embodiments, a binder is applied as the first layer of the friction reducer coating, directly in contact with the external surface of the coke proppant particles. Such binder may include but is not limited to one or more proteins, one or more amino acids, one or more sugars, and/or one or more polysaccharides. A layer of the friction reducer can then be applied over the binder layer. In other embodiments, a binder may be mixed with a friction reducer, and the mixture forms at least a portion of the coating on or over the outer surfaces of the coke proppant particles. In certain embodiments, a binder layer may cover various portions of the outer surfaces of the coke proppant particles, and the friction reducer may directly contact and cover certain portions of the outer surfaces of the coke proppant particles as well as a portion or the entirety of the binder layer.

In some embodiments, the deposition (or coating) process involves spraying a liquid binder onto the coke proppant particles to obtain pre-coated coke proppant particles and subsequently mixing the pre-coated coke proppant particles with the friction reducer in a dry powder form. In other embodiments, the deposition (or coating) process involves forming an aqueous solution or slurry of the friction reducer, mixing the coke proppant particles with the aqueous solution or slurry to obtain wet coke proppant particles, and subsequently drying the wet coke proppant particles. Moreover, any other suitable type of deposition process may be additionally or alternatively utilized to apply the friction reducer coating to the coke proppant particles.

The friction reducer-coated coke proppant particles described herein provides a number of advantages in a fracturing fluid relative to coke proppant particles not coated with friction reducer. Although part of the friction reducer coating may be lost during transport of the friction reducer-coated proppant particles in the fracturing fluid flowing in the fractures in a subterranean formation, some of the coating remains on the outer surface of the particles, enabling lower friction between the friction reducer-coated proppant particles and the fracture contact surfaces, as well as lower friction between the proppant particles when they contact each other. The relatively thin residual friction reducer coating barely increases the overall size of the coated coke proppant particles. Moreover, the friction reducer coating lowers the overall apparent density of the friction reducer-coated coke proppant particles compared to the coke proppant particles without the friction reducer coating, improving buoyancy compared to uncoated coke proppant particles in the fracturing fluid. As a result of the lower friction, the friction reducer-coated coke proppant particles can travel further than uncoated coke proppant particles, particularly in tortuous secondary fractures, and therefore propping longer fractures than a process using only coke proppant particles not coated with the friction reducer coating. Additionally, as a result of higher buoyancy, the friction reducer-coated coke proppant particles can be carried further and for a longer time by the carrier fluid than uncoated coke proppant particles. As a result, the amount of friction reducer added to the carrier fluid as an additive may be reduced (or friction reducer may potentially be eliminated as part of the carrier fluid and/or as an additive) for instances in which the friction reducer-coated coke proppant particles are used.

As described further herein, the coke proppant particles may include any suitable types of coke, such as, for example, fluid coke, flexicoke, delayed coke, thermally post-treated coke, pyrolysis coke, and/or coal-derived coke (e.g., blast furnace coke particles and/or metallurgical coke particles). Moreover, in some embodiments, at least a portion of such coke proppant particles are provided as microproppant coke particles.

With regard to petroleum coke specifically, we have found that petroleum coke particles possess a number of properties and features that alleviate difficulties that are typically encountered during the hydraulic fracturing of subterranean formations via hydrocarbon wells. First, the low density of petroleum coke enables petroleum coke proppant particles to transport further within the wellbore and the corresponding hydraulic fractures as compared to non-coke proppant particles. In addition, we have found that petroleum coke proppant particles are less prone than non-coke proppant particles to flow back into the wellbore once the hydraulic fracturing operation is complete and the hydrocarbon well is brought on production. Moreover, we have discovered that petroleum coke proppant particles are less prone than non-coke proppant particles to settle around any diversion materials within the wellbore, thus enabling dissolvable, biodegradable, or self-destructible diversion materials (such as dissolvable plugs, for example) to be effectively used within the wellbore. Furthermore, we have found that the utilization of petroleum coke proppant particles reduces the likelihood of cluster-level screen-out as compared to the utilization of non-coke proppant particles. Each of these factors may advantageously reduce or eliminate the need to perform a wellbore cleanout procedure.

Moreover, the low density of petroleum coke particles enables petroleum coke proppant particles to transport further within each stage and further throughout the perforation clusters as compared to non-coke proppant particles. As a result, fracturing fluids including petroleum coke proppant particles will more evenly and efficiently flow throughout the stages and into the perforation clusters and, therefore, also more efficiently travel into the tips (or at least within proximity to the tips) of the formed hydraulic fractures.

As described herein, petroleum coke has sufficient crush strength to maintain propped fractures upon the removal of hydraulic pressure and to maintain efficient conductivity once the wellbore is brought on production. In addition, the relatively low density of petroleum coke may decrease or eliminate the need to use gelled fracturing fluids, thereby avoiding the costs associated with gelation. Furthermore, using petroleum coke may potentially reduce required injection pressures, reduce overall water consumption, and avoid the need for frequent wellbore cleanouts.

Effective proppant particles are typically associated with a variety of particular characteristics or properties, including efficient proppant particle transport within a carrier fluid, sufficient strength to maintain propped fractures upon the removal of hydraulic pressure, and efficient conductivity once the wellbore is brought on production. With respect to the proppant particle transport properties, the settling rate of a proppant particle within a fracturing fluid at least in part determines its transport capacity within a hydraulic fracture. The settling rate of a proppant particle can be determined using Equation (1).

$$v = \frac{{ρ}_{p} - {ρ}_{f}}{18 η} g {σ}^{2} , \qquad ( 1 )$$

In Equation (1), v is the settling rate of the proppant particle, ρₚ-ρ_{f} is proportional to the density difference between the proppant particle and the carrier fluid, η is the viscosity of the carrier fluid, g is the gravitational constant, and σ² is proportional to the square of the proppant particle size. As will be appreciated, proppant particles having lower apparent densities and/or smaller particle sizes settle at a slower rate within an identical carrier fluid (thus having better transport) compared to higher apparent density and/or larger particle sized proppant particles.

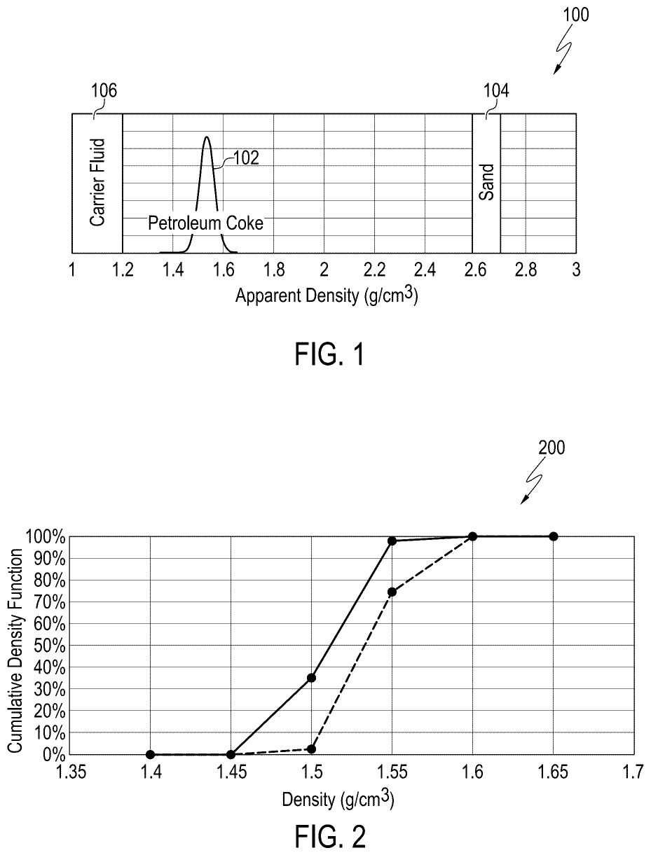

We have found that coke particles, particularly petroleum coke particles, are particularly well-suited for utilization as a proppant during hydraulic fracturing operations due at least in part to the relatively low apparent densities of petroleum coke particles as compared to non-coke proppants (e.g., sand). This is illustrated by FIG. 1, which is a graph 100 comparing the apparent densities of petroleum coke particles within a petroleum coke sample to the apparent densities of sand particles within a sand sample. Specifically, the apparent densities of the petroleum coke particles (i.e., in this example, fluid coke particles) and the sand particles were determined in the laboratory by measuring the mass of each type of particle that settled in a given density of brine. Based on these measurements, the apparent densities of the petroleum coke particles ranged from around 1.3 g/cm³ to around 1.7 g/cm³, as shown at 102, while the apparent densities of the sand particles ranged from around 2.6 g/cm³ to around 2.7 g/cm³, as shown at 104. Therefore, the apparent density of petroleum coke is significantly lower than the apparent density of sand. Moreover, the apparent density of typical carrier fluid (e.g., water) generally ranges from around 1.0 g/cm³ to around 1.2 g/cm³, as shown at 106. Moreover, FIG. 2 is a graph 200 showing cumulative density functions for fluid coke particles within two fluid coke samples. As shown, the densities of the fluid coke particles ranged from around 1.4 g/cm³ to around 1.65 g/cm³.

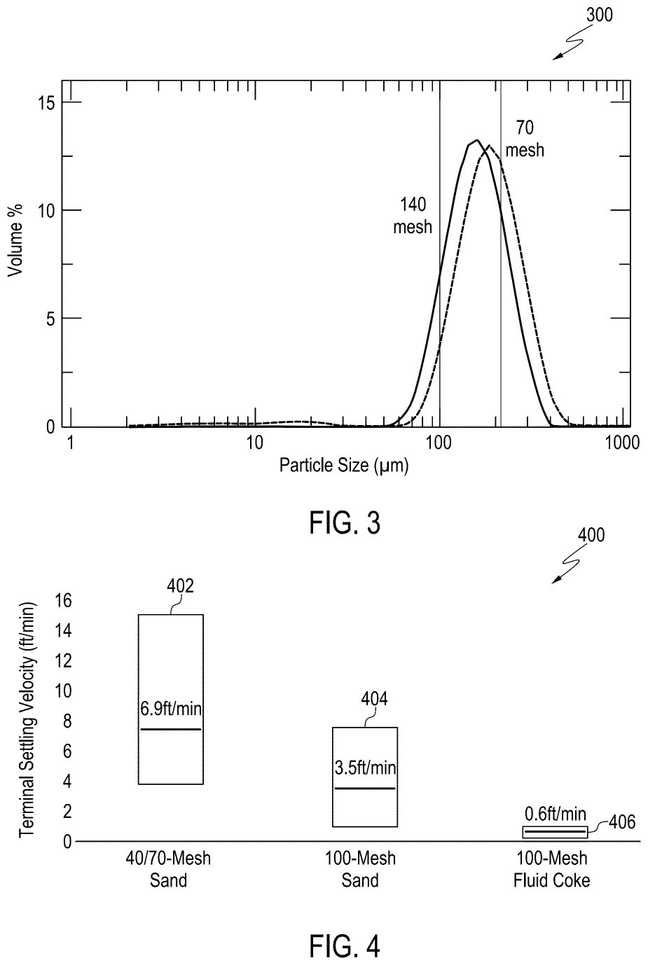

The transport properties of coke proppant particles are further enhanced by the differentiated size distribution of such particles. Specifically, while the particle sizes of sand generally ranges from around 105 micrometers (μm) to around 850 μm (i.e., around 140 mesh to around 20 mesh), the particle size of petroleum coke can be varied such that it either approximates the particle size of sand or is provided with smaller particle sizes. As an example, FIG. 3 is a graph 300 showing particle size distributions for fluid coke particles within two fluid coke samples. As shown, the particle sizes for the two fluid coke samples were from around 100 μm to around 210 μm (i.e., around 140 mesh to around 70 mesh), which encompasses the lower end of the range of typical particle sizes for different types of sand. Moreover, as described further herein, petroleum coke particles may also be provided with much smaller particle sizes via the utilization of microproppant coke particles, which may have particle sizes of at most 105 μm (140 mesh) or, in some cases, at most than 88 μm (170 mesh), but potentially within a range from around 0.0001 μm to 105 μm (e.g., from around 0.0001, 0.001, 0.01, 0.1 μm to 0.5, 1.0, 2.0, 5.0, 8.0 10 μm, to 15, 20, 25, 30, 35, 40, 45 μm, to 50, 53, 55, 60, 63, 65 μm, to 74, 75, 80, 85, 88, 90, 95, 100, 105 μm).

As described above with respect to Equation (1), because petroleum coke particles have lower apparent densities and similar or smaller particle sizes as compared to non-coke proppants (e.g., sand), such petroleum coke particles also have lower settling rates within the carrier fluid and, therefore, have enhanced transport properties as compared to sand. This is illustrated by FIG. 4, which is a bar graph 400 showing the terminal settling velocities in recycled water for sand particles within a 40/70-mesh sand sample, sand particles within a 100-mesh sand sample, and fluid coke particles within a 100-mesh fluid coke sample. In particular, the average terminal settling velocity for the sand particles within the 40/70-mesh sand sample was 6.9 feet per minute (ft/min) (0.04 meters per second (m/s)), as shown at 402; the average terminal settling velocity for the sand particles within the 100-mesh sand sample was 3.5 ft/min (0.02 m/s), as shown at 404; and the average terminal settling velocity for the fluid coke particles within the 100-mesh fluid coke sample was 0.6 ft/min (0.003 m/s), as shown at 406. Therefore, fluid coke particles (which are representative of other types of petroleum coke particles) will clearly transport further into hydraulic fractures than sand particles. As a result, proppants formed at least in part from petroleum coke are capable of propping extended regions of new and/or existing hydraulic fractures that would not be effectively propped by non-coke proppants, thus increasing the overall SRV in the subterranean formation and leading to increased production performance for the corresponding hydrocarbon well.

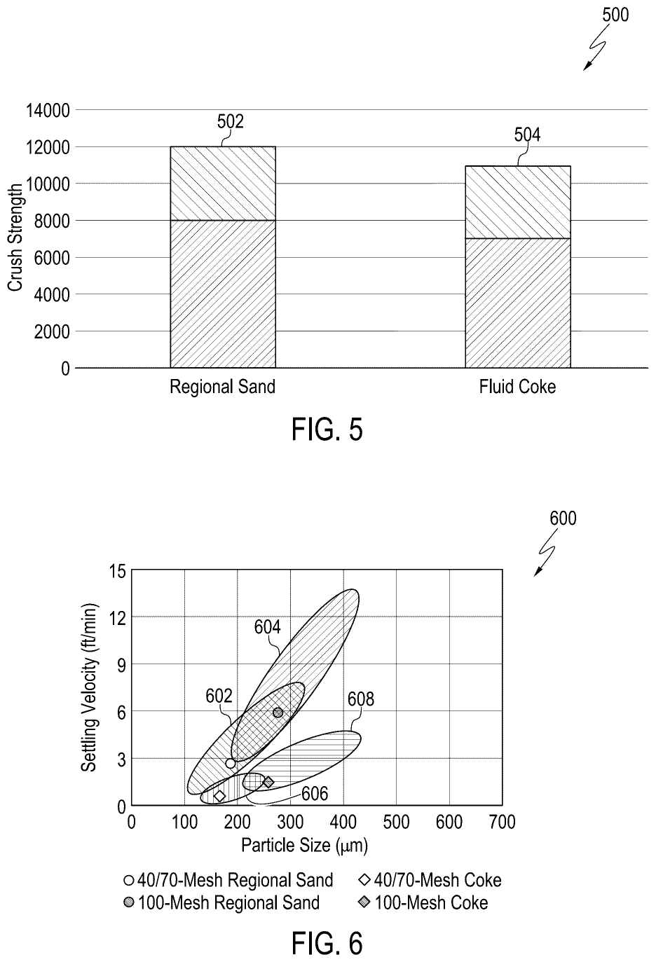

Furthermore, the crush strength of a proppant particle is a measure of the particle's ability to withstand stresses within a hydraulic fracture, with efficient proppant particles being capable of resisting sustained loads within hydraulic fractures during the lifetime of the corresponding wellbore without comprising the hydraulic conductivity of such hydraulic fractures. As a result, proppant particles with higher crush strengths are favorable. According to API RP-19C standards, adequate proppant particles should have a crush strength indicating that less than 10% of fines are produced under a stress of 5,000 psi. In this regard, the crush strength of petroleum coke is advantageously comparable to the crush strength of sand. This is illustrated by FIG. 5, which is a bar graph 500 comparing the crush strengths of sand particles within a regional sand sample, as shown at 502, to the crush strengths of fluid coke particles within a fluid coke sample, as shown at 504. Such crush strength was determined according to API K crush strength testing by applying stress to the respective particles in increments of 1,000 psi until 10% fines were formed, with the crush strength of the particles within each sample being the pressure (in psi) at which 10% fines were formed. As shown in FIG. 5, the crush strength of fluid coke (which is representative of other types of petroleum coke) is comparable to the crush strength of regional sand.

With regard to the erosive properties of petroleum coke particles as compared to sand particles, it is noted that sand particles have a hardness of around 7 on the Mohs hardness scale, while petroleum coke particles have a hardness of less than around 6 on the Mohs hardness scale. Therefore, petroleum coke particles are expected to be less erosive than sand particles and are less likely to cause substantial erosion within the production causing string, including, in particular, the erosion of the perforation clusters.

FIG. 6 is a graph 600 showing settling velocity as a function of particle size for several different mesh sizes of sand and petroleum coke. Specifically, the graph 600 shows settling velocity (in feet per minute (ft/min)) as a function of particle size (in μm) for 40/70-mesh regional sand (as represented by a first region 602), 100-mesh regional sand (as represented by a second region 604), 40/70-mesh petroleum coke (as represented by a third region 606), and 100-mesh petroleum coke (as represented by a fourth region 608), where the settling velocity value is based on a modified Stokes settling velocity. As illustrated by the graph 600, petroleum coke has a significantly lower settling rate (or velocity) than sand for comparable particle sizes. As a result, proppant particulates formed from petroleum coke material will perform better than proppant particulates formed from sand in terms of transport capacity within the fractures created during a hydraulic fracturing operation.

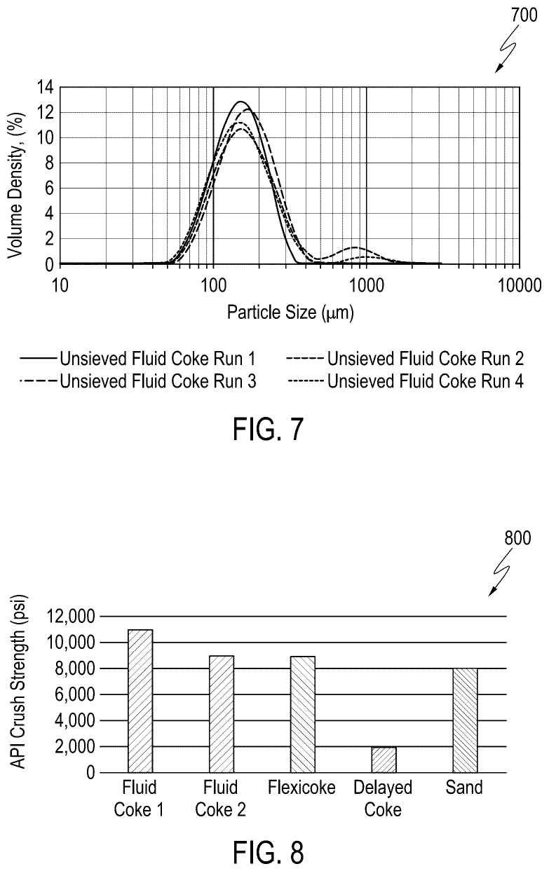

With regard to particle size, fluid coke particles and flexicoke particles are provided in a wide range of sizes. This is illustrated by FIG. 7, which is a graph 700 showing particle size distributions for four unsieved fluid coke samples. The particle sizes were measured using laser particle size analysis (LPSA), which is a rapid and precise optical sieve technique for particle size analysis that works on the principle of measuring the intensity of light scattered as a laser beam passes through a dispersed particulate sample. In this case, particles with sizes exceeding 3 millimeters (mm) were removed prior to the analysis. As shown in FIG. 7, all four unsieved fluid coke samples exhibited a wide range of particle sizes upon exiting the reactor.

In general, the crush strength of petroleum coke particles has been shown to range from around 8,000 psi to around 12,000 psi. This is illustrated, in part, by FIG. 8, which is a bar graph 800 comparing the crush strengths of different types of proppant. Specifically, FIG. 8 compares the crush strengths of two fluid coke sample, a flexicoke sample, a delayed coke sample, and a sand sample. As shown in the bar graph 800, the crush strengths of fluid coke and flexicoke approximate the crush strength of sand.

Any suitable type(s) of petroleum coke and/or other type(s) of coke may be used for the coke proppant particles described herein. For example, the coke proppant particles may include but are not limited to fluid coke particles, flexicoke particles, delayed coke particles, thermally post-treated coke particles, pyrolysis coke particles, coal-derived coke particles (e.g., blast furnace coke particles and/or metallurgical coke particles), microproppant coke particles, or any combination thereof.

In certain embodiments, the coke proppant particles can be provided with a range of different particle sizes, for example, anywhere from around 74 μm (200-mesh) to around 860 μm (20-mesh) (e.g., 74, 84, 89, 97, 104, 107 μm, to 109, 117, 130, 140, 160, 180 μm, to 200, 230, 280, 425, 450, 520 μm, to 700, 860 μm). For some embodiments in which improved proppant particle suspension is a primary concern, the coke proppant particles may be provided with a median particle size of around 210 μm (70-mesh) or larger. In addition, because the friction reducer coating effectively reduces the settling velocity of the coke proppant particles, coke proppant particles with larger particle sizes, such as particle sizes ranging from 210 μm to 860 μm, can still be used with sufficient transport capability, enabling them to reach distant fractures that coke proppant particles with the same size without the friction reducer coating are unable to reach.

For embodiments in which flexicoke particles are utilized as at least a portion of the coke proppant particles described herein, such flexicoke particles are produced via the FLEXICOKING™ process. Briefly, the FLEXICOKING™ process integrates a cracking reactor, a heater, and a gasifier into a common fluidized-solids (coke) circulating system. A feed stream (of residua) is fed into a fluidized bed, along with a stream of hot recirculating material to the reactor. From the reactor, a stream containing coke is circulated to the heater vessel, where it is heated. The hot coke stream is sent from the heater to the gasifier, where it reacts with air and steam. The gasifier product gas, referred to as coke gas, containing entrained coke particles, is returned to the heater and cooled by cold coke from the reactor to provide a portion of the reactor heat requirement. A return stream of coke sent from the gasifier to the heater provides the remainder of the heat requirement. The coke meeting the heat requirement is then circulated to the reactor, and the feed stream is thermally cracked to produce light hydrocarbon liquids that are removed from the reactor and recovered using conventional fractionating equipment. Fluid coke is formed from the thermal cracking process and settles (deposits) onto the “seed” fluidized bed coke already present in the reactor. The resultant at least partially gasified coke is flexicoke. In some instances, the coke from the thermal cracking process deposits in a pattern that appears ring-like atop the surface of the seed coke. Flexicoke is continuously withdrawn from the system during normal FLEXICOKING™ processing (e.g., from the reactor or after it is streamed to the heater via an elutriator) to ensure that the system maintains particles of coke in a fluidizable particle size range. Accordingly, flexicoke is a readily available byproduct of the FLEXICOKING™ process.

The gasification process of FLEXICOKING™ results in substantial concentration of metals in the flexicoke product and additionally allows for operational desulfurization of sulfur from the flexicoke. The gasification can be minimized or maximized to influence the sulfur content (minimization=lower sulfur content). Accordingly, unlike cokes formed in other processes, flexicoke has a comparatively high metal content and a comparatively lower sulfur content that can be manipulated.

In various embodiments, the flexicoke particles may have a carbon content that is in a range from around 85 weight percent (wt %) to around 99 wt % (e.g., from around 85, 87, 89, 91 wt %, to 93, 95, 97, 99 wt %); a weight ratio of carbon to hydrogen that is in a range from around 80:1 to around 95:1 (e.g. from around 80:1, 85:1, to 90:1, 95:1); and an impurities content (i.e., a weight percent of all components other than carbon and hydrogen) that is in a range from around 1 wt % to around 10 wt % (e.g., around found 1, 2, 3, 4, 5 wt %, to 6, 7, 8, 9, 10 wt %). Flexicoke also has a higher metal content than other cokes. In particular, the flexicoke particles may have a combined vanadium and nickel content that is in a range from around 3,000 parts per million (ppm) to around 45,000 ppm (e.g., from around 3,000, 10,000, 15,000 ppm, to 20,000, 25,000, 30,000 ppm, to 35,000, 40,000, 45,000 pm). In addition, the flexicoke particles may have a sulfur content that is in a range from 0 wt % to around 5 wt % (e.g. from 0, 1, 2 wt %, to 3, 4, 5 wt %), as well as a nitrogen content that is in a range from 0 wt % to around 3 wt % (e.g., from 0, 0.5, 1.0, 1.5 wt %, to 2.0 2.5, 3.0 wt %).

The apparent density of the flexicoke particles may be in a range from around 1.0 g/cm³ to around 2.0 g/cm³ (e.g., from around 1.0, 1.1, 1.2, 1.3 g/cm³, to 1.4, 1.5, 1.6, 1.7 g/cm³, to 1.8, 1.9, 2.0 g/cm³). Conventional sand-based proppants generally have apparent densities of at least around 2.5 g/cm³. Thus, the flexicoke particles have substantially lower apparent densities compared to conventional sand-based proppants, which is indicative of their comparably more effective transport and lower settling rates within a fracture formed as part of a hydraulic fracturing operation.

For embodiments in which fluid coke particles are utilized as at least a portion of the coke proppant particles described herein, such fluid coke particles are obtained via a fluid coking process. The fluid coking process may be manipulated in various ways to produce fluid coke particles having a number of distinctive characteristics. For example, the fluid coke particles may have a carbon content that is in a range from around 75 wt % to around 93 wt % (e.g., from around 75, 77, 79, 81, 83 wt %, to 85, 87, 91, 93 wt %); a weight ratio of carbon to hydrogen that is in a range from around 30:1 to around 50:1 (e.g., around 30:1, 35:1, to 40:1, 45:1, 50:1); and an impurities content that is in a range from around 5 wt % to around 25 wt % (e.g., from around 5, 10, 15 wt %, to 20, 25 wt %). The fluid coke particles may also have a sulfur content that is in a range from around 3 wt % to around 10 wt % (e.g., from around 3, 4, 5, 6 wt %, to 7, 8, 9, 10 wt %), as well as a nitrogen content that is in a range from around 0.5 wt % to around 3 wt % (0.5, 1.0, 1.5 wt %, to 2.0, 2.5, 3.0 wt %). In addition, the apparent density of the fluid coke particles may be in a range from around 1.4 g/cm³ to around 2.0 g/cm³ (e.g., from around 1.4, 1.5, 1.6 g/cm³, to 1.7, 1.8, 1.9, 2.0 g/cm³).

For embodiments in which delayed coke particles are utilized as at least a portion of the coke proppant particles described herein, such delayed coke particles are produced within a delayed coking unit via a delayed coking process. According to the delayed coking process, a preheated feedstock is introduced into a fractionator, where it undergoes a thermal cracking process in which long-chain hydrocarbons are split into shorter-chain hydrocarbons. The resulting lighter fractions are then removed as sidestream products. The fractionator bottoms, which include a recycle stream of heavy product, are heated in a furnace, which typically has an outlet temperature that is in a range from around 480° C. to around 515° C. The heated feedstock then enters a reactor, referred to as a “coke drum,” which typically operates at temperatures that are in a range from around 415° C. to around 450° C. Within the coke drum, the cracking reactions continue. The resulting cracked products then exit the coke drum as an overhead stream, while coke deposits on the inner surface of the coke drum. In general, this process is continued for a period of around 16 hours to around 24 hours to allow the coke drum to fill with coke. In addition, to allow the delayed coking unit to operate on a batch-continuous (or semi-continuous) basis, two or more coke drums are typically used. While one coke drum is on-line filling with coke, the other coke drum is being steam-stripped, cooled, decoked (e.g., via hydraulically cutting the deposited coke with water), pressure-checked, and warmed up. Moreover, the overhead stream exiting the coke drum enters the fractionator, where naphtha and heating oil fractions are recovered. The heavy recycle material is then typically combined with preheated fresh feedstock and recycled back into the process.

The delayed coke particles may exhibit the following properties: (1) a carbon content that is in a range from around 82 wt % to around 90 wt % (e.g., from around 82, 83, 84, 85 wt %, to 86, 87, 88, 89, 90 wt %); (2) a weight ratio of carbon to hydrogen that is in a range from around 15:1 to around 30:1 (e.g., from around 15:1, 20:1, to 25:1, 30:1); (3) a combined vanadium and nickel content that is in a range from around 100 ppm to around 3,000 ppm (e.g., from around 100, 500, 1,000, 1,500 ppm, to 2,000, 2,500, 3,000 ppm); (4) a sulfur content that is in a range from around 2 wt % to around 8 wt % (e.g., from around 2, 3, 4, 5 wt %, to 6, 7, 8 wt %); and/or (5) a nitrogen content that is in a range from around 1 wt % to around 2 wt % (e.g., from around 1.0, 1.2, 1.4 wt %, to 1.6, 1.8, 2.0 wt %), where such properties are measured on a dry, ash-free basis (or, in other words, not counting residual ash content and removing moisture before the analysis). In addition, the delayed coke particles may have a moisture content that is in a range from around 6 wt % to around 14 wt % (e.g., from around 6, 8, 10 wt %, to 12, 14 wt %) and a volatile matter content that is in a range from around 6 wt % to around 18 wt % (e.g., from around 6, 8, 10, 12 wt %, to 14, 16, 18 wt %), as measured on an as-received basis. Moreover, the apparent density of the delayed coke particles may be in a range from around 1.0 g/cm³ to around 1.7 g/cm³ (e.g., from around 1.0, 1.1, 1.2, 1.3 g/cm³, to 1.4, 1.5, 1.6, 1.7 g/cm³). Furthermore, the crush strength of the delayed coke particles may be comparable to the crush strengths of other types of petroleum coke particles.

For embodiments in which microproppant coke particles are utilized as at least a portion of the coke proppant particles described herein, such microproppant coke particles may include wet flexicoke fines and/or dry flexicoke fines produced as a byproduct of the FLEXICOKING™ process. Additionally or alternatively, the microproppant coke particles may include sieved fluid coke, sieved flexicoke, sieved delayed coke, sieved thermally post-treated coke, sieved pyrolysis coke, and/or sieved coal-derived coke (e.g., sieved blast furnace coke and/or sieved metallurgical coke). Additionally or alternatively, in some embodiments, the microproppant coke particles may include ground fluid coke, ground flexicoke, ground delayed coke, ground thermally post-treated coke, ground pyrolysis coke, and/or ground coal-derived coke (e.g., ground blast furnace coke and/or ground metallurgical coke). Moreover, any other suitable types of microproppant coke particles may be additionally or alternatively utilized.

With respect to the utilization of microproppant coke particles including wet and/or dry flexicoke fines as at least a portion of the coke proppant particles described herein, such flexicoke fines are byproducts of the FLEXICOKING™ process, which are collected as particles that were not recovered in the secondary cyclones of the heater within the flexicoker. More specifically, the particles are collected first in the tertiary cyclone as dry flexicoke fines, and the smaller particles that travel past the tertiary cyclone are then recovered in the venturi scrubber as wet flexicoke fines. While at least a portion of such flexicoke fines would typically be considered as waste, the present disclosure provides for the effective utilization of such flexicoke fines during hydraulic fracturing operations.

With respect to the utilization of microproppant coke particles including sieved fluid coke, sieved flexicoke, sieved delayed coke, sieved thermally post-treated coke, sieved pyrolysis coke, and/or sieved coal-derived coke (e.g., sieved blast furnace coke and/or sieved metallurgical coke) as at least a portion of the coke proppant particles described herein, any suitable type(s) of filters, screens, and/or associated machinery may be utilized to separate any suitable type(s) of bulk coke granules into larger particles as well as smaller particles that are suitable for utilization as the microproppant coke particles. Furthermore, with respect to the utilization of microproppant coke particles including ground fluid coke, ground flexicoke, ground delayed coke, ground thermally post-treated coke, ground pyrolysis coke, and/or ground coal-derived coke (e.g., ground blast furnace coke and/or ground metallurgical coke) as at least a portion of the coke proppant particles described herein, any suitable type(s) of grinding/milling technique(s) may be used to produce such microproppant coke particles. For example, in some embodiments, coke granules may be processed using hammer milling techniques, jet milling techniques, ball milling techniques, or the like, where each of these techniques generally involves crushing or pulverizing the coke granules to a suitable size and shape. Moreover, those skilled in the art will appreciate that any number of other grinding, milling, or other processing techniques may be additionally or alternatively used, depending on the details of the particular implementation.

In various embodiments, the microproppant coke particles that may be utilized according to embodiments described herein include particle sizes of at most 105 μm (140 mesh) or, in some cases, particle sizes of at most 88 μm (170 mesh), but potentially within a range from around 0.0001 μm to 105 μm (e.g., from around 0.0001, 0.001, 0.01, 0.1 μm to 0.5, 1.0, 2.0, 5.0, 8.0 10 μm, to 15, 20, 25, 30, 35, 40, 45 μm, to 50, 53, 55, 60, 63, 65 μm, to 74, 75, 80, 85, 88, 90, 95, 100, 105 μm).

Moreover, in various embodiments, such microproppant coke particles have an apparent density that is in a range from around 1.0 g/cm³ to around 2.0 g/cm³ (e.g., from around 1.0, 1.1, 1.2, 1.3 g/cm³, to 1.4, 1.5, 1.6, 1.7 g/cm³, to 1.8, 1.9, 2.0 g/cm³), although the exact apparent density of the particles may vary depending on the specific type(s) of coke utilized. By comparison, sand generally has an apparent density of at least around 2.5 g/cm³. Therefore, because the settling rate is proportional to the difference in density between the solid particles and the carrier fluid (as shown in expressions for both Stokes terminal settling velocity and Ferguson & Church settling velocity), such microproppant coke particles have a significantly lower settling rate than sand. As a result, proppant particles formed from microproppant coke particles will perform better than proppant particles formed from sand in terms of transport capacity within hydraulic fractures that are created, reopened, and/or extended during a hydraulic fracturing operation.

Furthermore, with respect to the utilization of microproppant coke particles as at least a portion of the coke proppant particles described herein, such microproppant coke particles provide a number of additional advantages over non-coke proppants. As an example, the microproppant coke particles are small enough to enter regions of secondary and natural fractures that cannot be effectively reached by non-coke proppants. As another example, due to the enhanced transport properties of the microproppant coke particles, such particles are capable of creating larger hydraulic fractures (i.e., by increasing one or more dimensions of such hydraulic fractures, such as the fracture lengths, heights, and/or azimuths) than non-coke proppants. As another example, the utilization of the microproppant coke particles as at least a portion of the coke proppant particles described herein may enable the flow rate of the fracturing fluid to be increased since a portion of the fracturing fluid may be diverted into the secondary hydraulic fractures and/or the natural fractures. As another example, the utilization of the microproppant coke particles as at least a portion of the coke proppant particles described herein may help to control the leak-off of the fracturing fluid into the secondary and natural fractures, thereby increasing the fracturing fluid efficiency and leading to the creation of larger conductive fractures.

With regard to the friction reducer that is used to coat the coke proppant particles according to embodiments described herein, such friction reducer may include but is not limited to a base polymer, such as a high-molecular-weight polyacrylamide, that will dissolve in water-based fracturing fluids and thereby reduce turbulence and friction within the wellbore and the corresponding formation. High-molecular-weight polyacrylamides, in particular, have densities of around 1.19 g/cm³ and are highly absorbent to water. Therefore, a friction reducer coating formed, at least in part, from a high-molecular-weight polyacrylamide, will swell while dissolving in a water-based fracturing fluid, and such swelling action combined with the relatively low density of such polymer as compared to the fracturing fluid will result in the formation of a low-density layer around the coke proppant particle. This, in turn, will reduce the particle's average apparent density to approach the apparent density of the surrounding fracturing fluid. Moreover, as the coke proppant particle proceeds downhole, the friction reducer coating will rapidly mix with the surrounding fracturing fluid and collide with the surrounding casing, causing such coating to partially or fully dissolve within the fracturing fluid and thereby impart friction-reducing properties to such fracturing fluid. Such friction-reducing properties may then enable the coke proppant particles to transport further into the corresponding formation, reaching extended regions of the corresponding hydraulic fractures.

In various embodiments, the friction reducer coating also includes a binder, which may form the first layer of the coating and may be used to enable the friction reducer to more effectively bind to the outer surface of the coke proppant particles. Such binder may include but is not limited to one or more proteins, one or more amino acids, one or more sugars, and/or one or more polysaccharides. A layer of the friction reducer can then be applied over the binder layer. In other embodiments, a binder may be mixed with a friction reducer, and the mixture forms at least a portion of the coating on or over the outer surfaces of the coke proppant particles. In certain embodiments, a binder layer may cover various portions of the outer surfaces of the coke proppant particles, and the friction reducer may directly contact and cover certain portions of the outer surfaces of the coke proppant particles as well as a portion or the entirety of the binder layer.

Any suitable deposition process may be utilized to provide the friction reducer coating on the coke proppant particles. As one non-limiting example, the deposition process may involve spraying a liquid binder or a liquid dispersion of a binder onto the coke proppant particles and then using an agitation process to coat the coke proppant particles with a dry powder form of the friction reducer. As another non-limiting example, the deposition process involves applying the friction reducer in an aqueous solution or an aqueous slurry suspension to the coke proppant particles and then drying the resulting coated coke proppant particles. In both examples, the deposition process may be performed in multiple steps to form multiple layers of coating (e.g., at least one layer of binder and at least one layer of friction reducer). In addition, in both examples, the weight of the friction reducer on the coke proppant particles may range from around 0.1 wt % to around 2.3 wt % friction reducer (e.g., 0.1, 0.2, 0.4, 0.6, 0.8, 1.0 wt % friction reducer to 1.2, 1.4, 1.6, 1.8, 2.0, 2.2, 2.3 wt % friction reducer) during the deposition process, based on the total weight of the friction reducer and the coke proppant particles. This weight percent is equivalent to 0.25 gpt (gallons per thousand gallons) to 6 gpt friction reducer. Moreover, for some embodiments in which high-viscosity friction reducer (HVFR) is utilized, the weight of the HVFR on the coke proppant particles may range from around 0.2 wt % to around 1.2 wt % HVFR (e.g., 0.2, 0.3, 0.4, 0.5, 0.6 wt % HVFR to 0.7, 0.8, 0.9, 1.0, 1.1, 1.2 wt % HVFR) during the deposition process, based on the total weight of the HVFR and the coke proppant particles.

In various embodiments, the thickness of the friction reducer coating (including the binder layer, if any) may range from around 1 μm to around 50 μm prior to mixing the friction reducer-coated coke proppant particles into the fracturing fluid. In some specific embodiments, the thickness may range from around 2 μm to around 25 μm prior to mixing the friction reducer-coated coke proppant particles into the fracturing fluid. However, the thickness may range from around 1, 5, 10 μm, to around 15, 20, 25 μm, to around 30, 35, 40, 45, 50 μm. Furthermore, in some embodiments, the friction reducer-coated coke proppant particles have apparent densities ranging from around 1.05 g/cm³ to 1.5 g/cm³ (e.g., from 1.05, 1.15, 1.25 g/cm³, to 1.35, 1.45, 1.5 g/cm³) when the friction reducer coating is fully hydrated with water, particularly when the average apparent density of the starting coke proppant particles prior to being coated with friction reducer is around 1.5 g/cm³.

Furthermore, in some embodiments, the deposition process may be performed at a facility that is located remotely from the hydraulic fracturing location. In other embodiments, the deposition process may be performed using a mobile processing facility that is located at the hydraulic fracturing location. In some cases, it may be preferable to perform the deposition process at (or within proximity to) the hydraulic fracturing location to reduce the risk of the coated particles becoming wet during transport.

Turning to details regarding exemplary characteristics of the fracturing fluid in which the friction reducer-coated coke proppant particles described herein may be employed, such fracturing fluid may include (in addition to the friction reducer-coated coke proppant particles) a flowable carrier fluid and one or more optional additives. In various embodiments, the fracturing fluid is formulated at the well site in a mixing process that is conducted concurrently with the pumping of the fracturing fluid into the wellbore during the hydraulic fracturing process. When the fracturing fluid is formulated at the well site, the friction reducer-coated coke proppant particles may be added in a manner similar to known methods for adding proppant to fracturing fluid.

The carrier fluid according to the present disclosure may be an aqueous carrier fluid that includes water or a nonaqueous carrier fluid that is substantially free of water. Aqueous carrier fluids may include, for example, fresh water, salt water (including seawater), treated water (e.g., treated production water), one or more other forms of aqueous fluid, or any combination thereof. One aqueous carrier fluid class is often referred to as slickwater, and the corresponding fracturing operations are often referred to as slickwater fracturing operations. Nonaqueous carrier fluids may include, for example, oil-based fluids (e.g., hydrocarbon, olefin, mineral oil), alcohol-based fluids (e.g., methanol), or any combination thereof. In various embodiments, the viscosity of the carrier fluid may be altered by foaming or gelling. Foaming may be achieved using, for example, air or other gases (e.g., CO₂, N₂), alone or in combination. Gelling may be achieved using, for example, guar gum (e.g., hydroxypropyl guar), cellulose, or other gelling agents, which may or may not be crosslinked using one or more crosslinkers, such as polyvalent metal ions or borate anions, among other suitable crosslinkers.

In some instances, the carrier fluid used according to embodiments described herein includes one or more aqueous carrier fluid types, particularly in light of the large volumes of fluid that are typically required (e.g., potentially around 60,000 to around 1,000,000 gallons per wellbore). The aqueous carrier fluid may or may not be gelled. The utilization of gelled aqueous carrier fluids (either crosslinked or un-crosslinked) may facilitate better proppant particle transport (i.e., reduce settling), as well as provide improved physical and chemical strength to withstand the temperatures, pressures, and shear stresses encountered by the fracturing fluid during a hydraulic fracturing operation. In some instances, the fracturing fluid includes an aqueous carrier fluid, which may or may not be foamed or gelled, and an acid (e.g., HCl) to further stimulate and enlarge pore areas of the matrix of fracture surfaces. It is to be appreciated that the low density of the friction reducer-coated coke proppant particles described herein may allow a reduction or elimination of the need to foam or gel the carrier fluid.

In various embodiments, the carrier fluid may be a high-salinity carrier fluid with a specific gravity of at most 1.1. In such embodiments, the high-salinity carrier fluid may be an aqueous carrier fluid constituting produced water, which can be cost-effectively and efficiently reused as carrier fluid. In such embodiments, the utilization of the high-salinity carrier fluid increases buoyancy effects, which can further improve the proppant transport capacity of the corresponding fracturing fluid.

In various embodiments, the fracturing fluid includes one or more additives. Such additives may include but are not limited to one or more acids, one or more biocides, one or more breakers, one or more corrosion inhibitors, one or more crosslinkers, one or more friction reducers (e.g., one or more high-viscosity friction reducers), one or more gels, one or more crosslinked gels, one or more oxygen scavengers, one or more pH control additives, one or more scale inhibitors, one or more surfactants, one or more weighting agents, one or more inert solids, one or more fluid loss control agents, one or more emulsifiers, one or more emulsion thinners, one or more emulsion thickeners, one or more viscosifying agents, one or more foaming agents, one or more stabilizers, one or more chelating agents, one or more mutual solvents, one or more oxidizers, one or more reducers, one or more clay stabilizing agents, or any combination thereof. Notably, the fracturing fluid may or may not include one or more added friction reducers in addition to the friction reducer coating. However, for embodiments in which one or more friction reducers are included in the fracturing fluid, such friction reducers may be included at a relatively low concentration range of around 0.5 gpt to around 1.0 gpt (e.g., around 0.5, 0.6, 0.7 gpt, to 0.8, 0.9, 1.0 gpt), for example.

The methods described herein include the preparation of the fracturing fluid. In some embodiments, the friction reducer-coated coke proppant particles may be transported in dry form (e.g., via truck or rail) from a remote facility. The transported friction reducer-coated coke proppant particles may then be combined with the carrier fluid and the optional additives at the production site, either directly into the wellbore or by pre-mixing in a hopper or other mixing equipment. For example, in some embodiments, slugs of the friction reducer-coated coke proppant particles are added directly to the fracturing fluid (e.g., as it is introduced into the wellbore). In other embodiments, a portion or all of the fracturing fluid is pre-mixed at the production site. Any other suitable mixing or adding of the friction reducer-coated coke proppant particles to produce a desired fracturing fluid composition may also be used, without departing from the scope of the present disclosure.

The methods of hydraulic fracturing suitable for use in one or more embodiments described herein involve pumping the fracturing fluids at a high pump rate into a subterranean formation to form hydraulic fractures in the subterranean formation. In various embodiments, this process is conducted one stage at a time along a wellbore. Specifically, the stage of interest is hydraulically isolated from any other stages that have been previously hydraulically fractured and propped. In some embodiments, the stage of interest includes perforation clusters within the production casing string of the wellbore, which enable the fracturing fluids to flow out of the wellbore and into the subterranean formation. In some embodiments, the pump rate of the fracturing fluids during the hydraulic fracturing operation is at least around 20 barrels per minute (bbl/min) (0.05 cubic meters per second (m³/s)), preferably at least around 30 bbl/min (0.08 m³/s), and more preferably at least 50 bbl/min (0.14 m³/s) and at most 1000 bbl/min (2.73 m³/s) at one or more time durations during the hydraulic fracturing operation (e.g., the rate may be constant, steadily increased, or pulsed). These high rates may, in some embodiments, be utilized after around 10% of the entire volume of fracturing fluid to be pumped into the subterranean formation has already been injected. That is, at the early periods of the hydraulic fracturing operation, the pump rate may be lower and as hydraulic fractures begin to form, the pump rate may be increased. Generally, the average pump rate of the fracturing fluids throughout the hydraulic fracturing operation may be around 10 bbl/min (0.03 m³/s), preferably around 15 bbl/min (0.04 m³/s), and more preferably at least 25 bbl/min (0.07 m³/s) and at most 250 bbl/min (0.68 m³/s). Typically, the pump rate of the fracturing fluids during the hydraulic fracturing operation for more than 30% of the time required to complete the hydraulic fracturing with respect to a particular stage may be in the range of around 20 bbl/min (0.05 m³/s) to around 150 bbl/min (0.41 m³/s), or around 40 bbl/min (0.11 m³/s) to around 120 bbl/min (0.33 m³/s), or around 40 bbl/min (0.11 m³/s) to around 100 bbl/min (0.27 m³/s).

In various embodiments, the methods of hydraulic fracturing described herein may be performed such that the concentration of the friction reducer-coated coke proppant particles (and any other type(s) of proppant particles) within the injected fracturing fluid is altered on-the-fly or in real-time while the hydraulic fracturing operation is being performed, such that the hydraulic pressure is maintained in the subterranean formation and the hydraulic fractures. For example, in some embodiments, the initially-injected fracturing fluid is injected at a low pump rate and includes around 1 weight percent (wt %) proppant particles (i.e., including the friction reducer-coated coke proppant particles and any other type(s) of proppant particles) based on the total weight of the fracturing fluid (i.e., including the carrier fluid, the friction reducer-coated coke proppant particles, any other type(s) of proppant particles, and any additives). As hydraulic fractures begin to form and grow, the pump rate may be increased, and the concentration of the proppant particles may be increased in a stepwise fashion (with or without a corresponding stepwise increase in pump rate), with a maximum concentration of total proppant particles potentially reaching around 2.5 wt % to around 20 wt %, for example, based on the total weight of the fracturing fluid. For example, the maximum concentration of total proppant particles may reach at least 2.5 wt %, preferably at least 8 wt %, and more preferably at least 16 wt %. In some embodiments, all of the proppant particles are friction reducer-coated coke particles. In other embodiments, at one or more time periods during the hydraulic fracturing operation, at least around 2 wt % to around 100 wt % of any proppant particles suspended within the fracturing fluid are friction reducer-coated coke particles, such as at least around 2 wt %, preferably at least around 15 wt %, more preferably at least around 25 wt %, and up to 100 wt % in some cases.

With regard to the other types of proppant particles that may be included within the fracturing fluid and/or a separate fracturing fluid, such proppant particles may include but are not limited to uncoated coke proppant particles and/or non-coke proppant particles. Non-limiting examples of non-coke proppant particles that may be used include sand, crushed granite, ceramic beads, polymer particulates, LWP, and/or ULWP. Moreover, such other proppant particles may be blended directly into the fracturing fluid along with the friction reducer-coated coke proppant particles or may be added to a separate fracturing fluid that is introduced into the formation sequentially with the fracturing fluid including the friction reducer-coated coke proppant particles.

In various embodiments, the fracturing fluid including the friction reducer-coated coke proppant particles is introduced into the subterranean formation during the pad phase of the hydraulic fracturing operation to allow the friction reducer-coated coke proppant particles to travel within the fracturing fluid into the tips (or at least within proximity to the tips) of the formed hydraulic fractures. In such embodiments, the fracturing fluid including the friction reducer-coated coke proppant particles may also be introduced into the subterranean formation during the later phases of the hydraulic fracturing operation such that the later-introduced slurry of carrier fluid and friction reducer-coated coke proppant particles continues to displace the earlier-introduced slurry of carrier fluid and friction reducer-coated coke proppant particles further away from the wellbore. Moreover, in some embodiments, the fracturing fluid including the friction reducer-coated coke proppant particles is introduced into the subterranean formation throughout the hydraulic fracturing operation, either continuously or intermittently. In such embodiments, the ratio of friction reducer-coated coke proppant particles to other type(s) of proppant particles, if any, introduced into the subterranean formation may be maintained at a steady (or substantially steady) value, or the ratio may be modified as the hydraulic fracturing operation progresses.

The hydraulic fracturing methods described herein may be performed in drilled hydrocarbon-producing wellbores including vertical, deviated, highly deviated, and/or lateral sections. Such wellbores may be drilled into various types of unconventional subterranean formations, including but not limited to tight sandstone formations, tight carbonate formations, shale gas formations, coal bed methane formations, and/or tight oil formations. As described herein, such wellbores are typically completed using casing strings that are cemented into the subterranean formation. To contact the subterranean formation, a number of perforation clusters are typically created through the production casing string, in which case the wellbore may be referred to as a plug and perforated (“plug-and-perf”) cased-hole completion. Alternative completion techniques may be used without departing from the scope of the present disclosure, but in each completion technique, a finite length of the wellbore is exposed for hydraulic fracturing and injection of the fracturing fluid. This finite section is referred to herein as a “stage.” In plug-and-perf completions, the stage length may be based on a distance over which the tubular and cement has been perforated and may be in excess of around 25 ft (7.6 m), but more typically in excess of around 100 ft (30.5 m).

During the plug-and-perf process, the stage of interest may be isolated using one or more diversions materials such that the pressurized fracturing fluid flows through the perforation clusters within the particular stage and into the subterranean formation to generate one or more hydraulic fractures in only the stage area. Such diversion materials may include but are not limited to one or more types of plugs (e.g., bridge plugs, packers, baffle/plug combinations, or the like), one or more types of particulate diverters (e.g., sand, ceramic material, salt, wax, resin, and/or other compounds), one or more types of perforation plugging devices, one or more types of ball-and-seat devices (e.g., ball sealers, with or without retaining devices), one or more types of chemical diverters (e.g., liquids and/or gels), and/or one or more types of dart-and-sleeve devices (e.g., any type of sleeve device in which a ball or dart is dropped from the surface, contacting and opening a particular sleeve, which permits injections into a new stage, while simultaneously blocking flow to the stages below). Moreover, in some embodiments, at least a portion of such diversion materials are provided in dissolvable, biodegradable, or self-destructible form, such that the diversion materials are designed to dissolve, degrade, or self-destruct, respectively, and then flow out of the wellbore, potentially without performing a wellbore cleanout procedure.

For each linear foot of a stage, at least around 6 barrels (0.95 cubic meters (m³)), preferably around 24 barrels (3.8 m³), and more preferably at least 60 barrels (9.5 m³) and at most 6,000 barrels (953.9 m³) of fracturing fluid may be injected to grow the hydraulic fractures. In certain embodiments, for each linear foot of a stage, at least around 0.3 barrels (0.05 m³), preferably around 1.1 barrels (0.2 m³), and more preferably at least 2.8 barrels (0.4 m³) and at most 285 barrels (45.3 m³), or no more than 143 barrels (22.7 m³), or no more than 114 barrels (18.1 m³), of proppant particles (i.e., including the coke proppant particles and any other type(s) of proppant particles) may be injected to prop the hydraulic fractures.

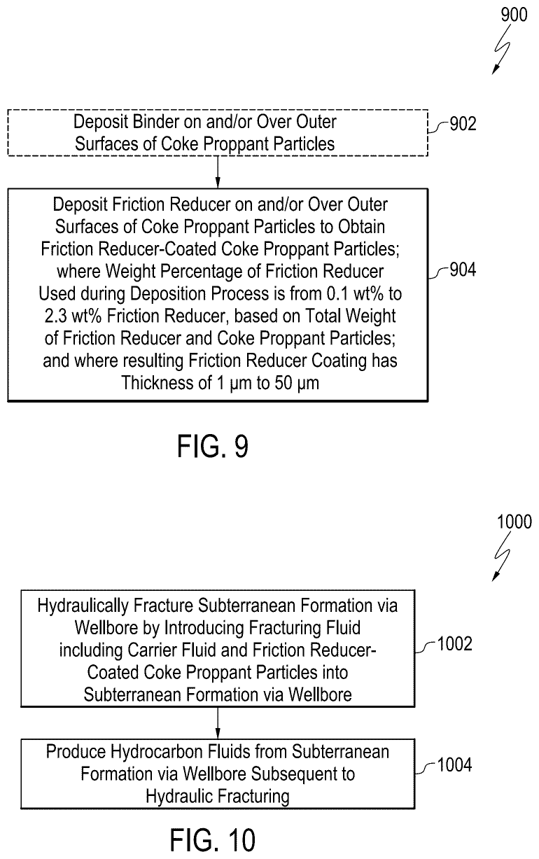

Turning to details of exemplary methods according to the present disclosure, FIG. 9 is a process flow diagram of an exemplary method 900 for making coke proppant particles with a friction reducer coating. The exemplary method 900 may begin at optional block 902, at which a binder may be deposited on and/or over the outer surfaces of coke proppant particles. Such binder may be intended to increase the ability of a friction reducer to adhere to the outer surface of the coke proppant particles, as described with respect to block 904.

At block 904, a friction reducer may be deposited on and/or over the outer surfaces of the coke proppant particles to obtain friction reducer-coated coke proppant particles. The weight percentage of the friction reducer used during the deposition process ranges from 0.1 wt % to 2.3 wt % (e.g., 0.1, 0.2, 0.4, 0.6, 0.8, 1.0 wt %, to 1.2, 1.4, 1.6, 1.8, 2.0, 2.2, 2.3 wt %), based on the total weight of the friction reducer and the coke proppant particles. For some embodiments in which HVFR is utilized, the weight percentage of the HVFR used during the deposition process may range from around 0.2 wt % to around 1.2 wt % HVFR (e.g., 0.2, 0.3, 0.4, 0.5, 0.6 wt %, to 0.7, 0.8, 0.9, 1.0, 1.1, 1.2 wt %, based on the total weight of the HVFR and the coke proppant particles. Moreover, the thickness of the friction reducer coating may range from around 1 μm to 50 μm. In some specific embodiments, the thickness may range from around 2 μm to around 25 μm. However, the thickness may range from around 1, 5, 10 μm, to around 15, 20, 25 μm, to around 30, 35, 40, 45, 50 μm. Furthermore, in some embodiments, the friction reducer-coated coke proppant particles may have apparent densities ranging from around 1.05 g/cm³ to 1.5 g/cm³ (e.g., from 1.05, 1.15, 1.25 g/cm³, to 1.35, 1.45, 1.5 g/cm³) when the friction reducer coating is fully hydrated with water, particularly when the average apparent density of the starting coke proppant particles is around 1.5 g/cm³.

In various embodiments, the friction reducer coating may include a copolymer having acrylamide structural units and acrylic acid structural units. In some such embodiments, the copolymer may further include AMPS structural units. In other such embodiments, the copolymer may further include TMAEA structural units.

In some embodiments, depositing the friction reducer on the outer surface of the coke proppant particles at block 904 may include spraying a liquid binder onto the coke proppant particles to obtain pre-coated coke proppant particles and subsequently mixing the pre-coated coke proppant particles with the friction reducer in a dry powder form. In other embodiments, depositing the friction reducer on the outer surface of the coke proppant particles at block 904 may include forming an aqueous solution or slurry of the friction reducer, mixing the coke proppant particles with the aqueous solution or slurry to obtain wet coke proppant particles, and subsequently drying the wet coke proppant particles.

In some embodiments, the method 900 may be performed using equipment positioned at the location of the subsequent hydraulic fracturing operation that is intended to utilize the friction reducer-coated coke proppant particles. This may help to prevent the friction reducer-coated coke proppant particles from becoming wet during transport to the hydraulic fracturing location. However, in other embodiments, the method 900 may be performed at a facility that is remotely located.

In some embodiments, at least a portion of the coke proppant particles may have particle sizes ranging from 74 μm to around 860 μm (e.g., 74, 84, 89, 97, 104, 107 μm, to 109, 117, 130, 140, 160, 180 μm, to 200, 230, 280, 425, 450, 520 μm, to 700, 860 μm). In some embodiments, the coke proppant particles may include fluid coke, flexicoke, delayed coke, thermally post-treated coke, pyrolysis coke, coal-derived coke (e.g., blast furnace coke and/or metallurgical coke), or any combination thereof. In some embodiments, the coke proppant particles may include only petroleum coke particles. In some embodiments, the coke proppant particles may include microproppant coke particles. In such embodiments, the microproppant coke particles may include wet flexicoke fines and/or dry flexicoke fines. Additionally or alternatively, in such embodiments, the microproppant coke particles may include sieved fluid coke, sieved flexicoke, sieved delayed coke, sieved thermally post-treated coke, sieved pyrolysis coke, and/or sieved coal-derived coke (e.g., sieved blast furnace coke and/or sieved metallurgical coke). Additionally or alternatively, in such embodiments, the microproppant coke particles may include ground fluid coke, ground flexicoke, ground delayed coke, ground thermally post-treated coke, ground pyrolysis coke, and/or ground coal-derived coke (e.g., ground blast furnace coke and/or ground metallurgical coke).

Those skilled in the art will appreciate that the exemplary method 900 of FIG. 9 is susceptible to modification without altering the technical effect provided by the present disclosure. For example, in some embodiments, one or more blocks may be omitted from the method 900, and/or one or more blocks may be added to the method 900. In practice, the exact manner in which the method 900 is implemented will depend at least in part on the details of the specific implementation.

FIG. 10 is a process flow diagram of an exemplary hydraulically fracturing process 1000 utilizing friction reducer-coated coke proppant particles. The exemplary process 1000 begins at block 1002, at which at which a subterranean formation may be hydraulically fractured via a wellbore by introducing a fracturing fluid including a carrier fluid and friction reducer-coated coke proppant particles into the subterranean formation via the wellbore. The friction reducer-coated coke proppant particles may be as described with respect to the method 900 of FIG. 9.

In some embodiments, the fracturing fluid may also include non-coke proppant particles. In such embodiments, the non-coke proppant particles may include but are not limited to sand, crushed granite, ceramic beads, polymer particulates, LWP, ULWP, or any combination thereof. Moreover, in some embodiments, the fracturing fluid may also include uncoated coke proppant particles that are added to the fracturing fluid subsequent to the deposition of the friction reducer coating on the outer surface of the coke proppant particles.

In some embodiments, the carrier fluid may be an aqueous carrier fluid that includes water. In other embodiments, the carrier fluid may be a nonaqueous carrier fluid that is substantially free of water. Moreover, in some embodiments, the fracturing fluid may also include one or more additives, including but not limited to one or more acids, one or more biocides, one or more breakers, one or more corrosion inhibitors, one or more crosslinkers, one or more gels, one or more crosslinked gels, one or more oxygen scavengers, one or more pH control additives, one or more scale inhibitors, one or more surfactants, one or more weighting agents, one or more inert solids, one or more fluid loss control agents, one or more emulsifiers, one or more emulsion thinners, one or more emulsion thickeners, one or more viscosifying agents, one or more foaming agents, one or more stabilizers, one or more chelating agents, one or more mutual solvents, one or more oxidizers, one or more reducers, and/or one or more clay stabilizing agents. In some such embodiments, at least a portion of such additives may be included as part of the friction reducer coating.

In some embodiments, the carrier fluid may be substantially free of a friction reducer that is contained in the coated coke proppant particles. In other embodiments, the coated coke proppant particles may include a first weight of a friction reducer of W1, and the carrier fluid includes a second weight of the friction reducer of W2, where 10%≤W1/(W1+W2)*100%≤90%, and the ratio of W1/(W1+W2) can range from, e.g., 0.1, 0.2, 0.3, 0.4, 0.5, to 0.6, 0.7, 0.8, 0.9.

In various embodiments, the fracturing fluid may be introduced into the subterranean formation via the wellbore for each of a number of stages of the hydrocarbon well. For each stage, the fracturing fluid may be introduced into the subterranean formation during at least a portion of the pad phase of the hydraulic fracturing operation, as well as during at least a portion of the remainder of the hydraulic fracturing operation.

Furthermore, at block 1004, hydrocarbon fluids may be produced from the subterranean formation via the wellbore subsequent to the hydraulic fracturing at block 1002. According to aspects and embodiments described herein, the utilization of the friction reducer-coated coke proppant particles as a portion of the proppant within the fracturing fluid introduced into the subterranean formation at block 1002 may increase the overall SRV in the subterranean formation, leading to enhanced production performance for the hydrocarbon well.

Those skilled in the art will appreciate that the exemplary process 1000 of FIG. 10 is susceptible to modification without altering the technical effect provided by the present disclosure. For example, in some embodiments, one or more blocks may be omitted from the process 1000, and/or one or more blocks may be added to the process 1000. In practice, the exact manner in which the process 1000 is implemented will depend at least in part on the details of the specific implementation.

This disclosure can include one or more of the following non-limiting aspects and embodiments:
A1. Friction reducer-coated coke proppant particles, comprising a friction reducer coating deposited on and/or over outer surfaces of coke proppant particles, wherein the friction reducer coating is provided with a thickness of 1 μm to 50 μm.
A2. The friction reducer-coated coke proppant particles of A1, wherein the friction reducer coating is provided with a thickness of 2 μm to 25 μm.
A3. The friction reducer-coated coke proppant particles of A1 or A2, wherein the friction reducer coating comprises a copolymer having acrylamide structural units and acrylic acid structural units.
A4. The friction reducer-coated coke proppant particles of A3, wherein the copolymer further comprises 2-acrylamido-2-methylpropane sulfonic acid (“AMPS”) structural units.
A5. The friction reducer-coated coke proppant particles of A3, wherein the friction reducer coating further comprises trimethylamino ethyl acrylate (“TMAEA”) structural units.
A6. The friction reducer-coated coke proppant particles of any of A1 to A5, wherein the friction reducer coating comprises a binder.
A7. The friction reducer-coated coke proppant particles of A6, wherein the friction reducer coating comprises (i) the binder layer abutting the outer surfaces of the coke proppant particles, and (ii) a friction reducer coating layer over the binder layer.
A8. The friction reducer-coated coke proppant particles of any of A1 to A7, wherein the friction reducer coating comprises a friction reducer; and wherein a weight percentage of the friction reducer is from 0.1 wt % to 2.3 wt %, based on a total weight of the friction reducer and the coke proppant particles.
A9. The friction reducer-coated coke proppant particles of A8, wherein the friction reducer comprises a high-viscosity friction reducer (“HVFR”), and wherein a weight percentage of the friction reducer is from 0.2 wt % to 1.2 wt %, based on the total weight of the friction reducer and the coke proppant particles.
A10. The friction reducer-coated coke proppant particles of any of A1 to A9, wherein the coke proppant particles comprise at least one of: fluid coke; flexicoke; delayed coke; thermally post-treated coke; pyrolysis coke; and coal-derived coke.
A11. The friction reducer-coated coke proppant particles of any of A1 to A10, wherein the coke proppant particles comprise microproppant coke particles.
A12. The friction reducer-coated coke proppant particles of any of A6 to A11, wherein the binder comprises at least one of a protein, an amino acid, a sugar, and a polysaccharide.
B1. A fracturing fluid, comprising: a carrier fluid; and friction reducer-coated coke proppant particles of any of A1 to A9.
B2. The fracturing fluid of B1, wherein the friction reducer-coated coke proppant particles have an apparent density of 1.05 g/cm³ to 1.5 g/cm³ when the friction reducer coating is hydrated with water.
B3. The fracturing fluid of B1 or B2, wherein the friction reducer coating comprises a copolymer having acrylamide structural units and acrylic acid structural units.
B4. The fracturing fluid of B3, wherein the copolymer further comprises 2-acrylamido-2-methylpropane sulfonic acid (“AMPS”) structural units.
B5. The fracturing fluid of B3, wherein the friction reducer coating further comprises trimethylamino ethyl acrylate (“TMAEA”) structural units.
B6. The fracturing fluid of any of B1 to B5, wherein the friction reducer coating comprises a binder.
B7. The fracturing fluid of B6, wherein the friction reducer coating comprises (i) the binder layer abutting the outer surfaces of the coke proppant particles, and (ii) a friction reducer coating layer over the binder layer.
B8. The fracturing fluid of any of B1 to B7, wherein the coke proppant particles comprise at least one of: fluid coke; flexicoke; delayed coke; thermally post-treated coke; pyrolysis coke; and coal-derived coke.
B9. The fracturing fluid of any of B1 to B8, wherein the coke proppant particles comprise microproppant coke particles.
B10. The fracturing fluid of any of B1 to B9, wherein the fracturing fluid further comprises non-coke proppant particles.
B11. The fracturing fluid of any of B1 to B10, wherein the fracturing fluid further comprises at least one additive, and wherein the at least one additive comprises at least one of an acid, a biocide, a breaker, a corrosion inhibitor, a crosslinker, a gel, a crosslinked gel, an oxygen scavenger, a pH control additive, a scale inhibitor, a surfactant, a weighting agent, an inert solid, a fluid loss control agent, an emulsifier, an emulsion thinner, an emulsion thickener, a viscosifying agent, a foaming agent, a stabilizer, a chelating agent, a mutual solvent, an oxidizer, a reducer, and a clay stabilizing agent.
B12. The fracturing fluid of B11, wherein the friction reducer coating further comprises at least a portion of the at least one additive.
B13. The fracturing fluid of any of B1 to B12, wherein at least a portion of the coke proppant particles have a particle size from 210 μm to 860 μm.
B14. The fracturing fluid of any of A6 to B13, wherein the binder comprises at least one of a protein, an amino acid, a sugar, and a polysaccharide. C1. A method for making friction reducer-coated coke proppant particles, comprising depositing a friction reducer on and/or over outer surfaces of coke proppant particles to obtain friction reducer-coated coke proppant particles; wherein a weight percentage of the friction reducer used during the deposition process is from 0.1 wt % to 2.3 wt %, based on a total weight of the friction reducer and the coke proppant particles; and wherein a thickness of the resulting friction reducer coating is 1 μm to 50 μm.
C2. The method of C1, wherein the friction reducer comprises a high-viscosity friction reducer (“HVFR”), and wherein a weight percentage of the friction reducer used during the deposition process is from 0.2 wt % to 1.2 wt %, based on the total weight of the friction reducer and the coke proppant particles.
C3. The method of C1 or C2, wherein the friction reducer-coated coke proppant particles have an apparent density of 1.05 g/cm³ to 1.5 g/cm³ when the friction reducer coating is hydrated with water.
C4. The method of any of C1 to C3, wherein the thickness of the friction reducer coating is 2 μm to 25 μm.
C5. The method of any of C1 to C4, wherein the friction reducer comprises a copolymer having acrylamide structural units and acrylic acid structural units.
C6. The method of C5, wherein the copolymer further comprises 2-acrylamido-2-methylpropane sulfonic acid (“AMPS”) structural units.
C7. The method of C5, wherein the copolymer further comprises trimethylamino ethyl acrylate structural units.
C8. The method of any of C1 to C7, wherein the friction reducer coating further comprises a binder, and wherein the method comprises depositing the binder on the outer surface of the coke proppant particles prior to depositing the friction reducer on the outer surface of the coke proppant particles.
C9. The method of any of C1 to C8, wherein depositing the friction reducer on the outer surface of the coke proppant particles comprises: spraying a liquid binder onto the coke proppant particles to obtain pre-coated coke proppant particles; and subsequently mixing the pre-coated coke proppant particles with the friction reducer in a dry powder form.
C10. The method of any of C1 to C8, wherein depositing the friction reducer on the outer surface of the coke proppant particles comprises: forming an aqueous solution or slurry of the friction reducer; mixing the coke proppant particles with the aqueous solution or slurry to obtain wet coke proppant particles; and subsequently drying the wet coke proppant particles.
C11. The method of any of C1 to C10, wherein the coke proppant particles comprise at least one of: fluid coke; flexicoke; delayed coke; thermally post-treated coke; pyrolysis coke; and coal-derived coke.
C12. The method of any of C1 to C11, wherein the coke proppant particles comprise microproppant coke particles.
C13. The method of any of C1 to C12, wherein the coke proppant particles have a particle size of 74 μm to 860 μm.
D1. A method for making a fracturing fluid, comprising: providing friction reducer-coated coke proppant particles of any of A1 to A12; and mixing the friction reducer-coated coke proppant particles with a carrier fluid and optionally one or more of the following additives: an acid, a biocide, a breaker, a corrosion inhibitor, a crosslinker, a gel, a crosslinked gel, an oxygen scavenger, a pH control additive, a scale inhibitor, a surfactant, a weighting agent, an inert solid, a fluid loss control agent, an emulsifier, an emulsion thinner, an emulsion thickener, a viscosifying agent, a foaming agent, a stabilizer, a chelating agent, a mutual solvent, an oxidizer, a reducer, and a clay stabilizing agent.
D2. The method of D1, wherein the carrier fluid is substantially free of a friction reducer that is contained in the coated coke proppant particles.
D3. The method of D1, wherein the coated coke proppant particles comprise a first weight of a friction reducer of W1; wherein the carrier fluid comprises a second weight of the friction reducer of W2; and wherein 10%≤W1/(W1+W2)*100%≤90%.
E1. A method for hydraulic fracturing a subterranean formation, comprising introducing the fracturing fluid described with respect to any of B1 to B14 into the subterranean formation.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present disclosure may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present disclosure includes all alternatives, modifications, and equivalents falling within the true spirit and scope of the appended claims.

What is claimed is:

1. Friction reducer-coated coke proppant particles, comprising a friction reducer coating deposited on and/or over outer surfaces of coke proppant particles, wherein the friction reducer coating is provided with a thickness of 1 micrometer (μm) to 50 μm.

2. The friction reducer-coated coke proppant particles of claim 1, wherein the friction reducer coating is provided with a thickness of 2 μm to 25 μm.

3. The friction reducer-coated coke proppant particles of claim 1, wherein the friction reducer coating comprises a copolymer having acrylamide structural units and acrylic acid structural units.

4. The friction reducer-coated coke proppant particles of claim 3, wherein the copolymer further comprises 2-acrylamido-2-methylpropane sulfonic acid structural units.

5. The friction reducer-coated coke proppant particles of claim 3, wherein the friction reducer coating further comprises trimethylamino ethyl acrylate structural units.

6. The friction reducer-coated coke proppant particles of claim 1, wherein the friction reducer coating comprises a binder.

7. The friction reducer-coated coke proppant particles of claim 6, wherein the friction reducer coating comprises (i) a binder layer abutting the outer surfaces of the coke proppant particles, and (ii) a friction reducer coating layer over the binder layer.

8. The friction reducer-coated coke proppant particles of claim 1, wherein the friction reducer coating comprises a friction reducer; and wherein a weight percentage of the friction reducer is from 0.1 wt % to 2.3 wt %, based on a total weight of the friction reducer and the coke proppant particles.

9. The friction reducer-coated coke proppant particles of claim 8, wherein the friction reducer comprises a high-viscosity friction reducer, and wherein a weight percentage of the friction reducer is from 0.2 wt % to 1.2 wt %, based on the total weight of the friction reducer and the coke proppant particles.

10. A fracturing fluid, comprising:
a carrier fluid; and
friction reducer-coated coke proppant particles of claim 1.

11. The fracturing fluid of claim 10, wherein the friction reducer-coated coke proppant particles have an apparent density of 1.05 grams per cubic centimeter (g/cm³) to 1.5 g/cm³ when the friction reducer coating is hydrated with water.

12. The fracturing fluid of claim 10, wherein the friction reducer coating comprises a copolymer having acrylamide structural units and acrylic acid structural units.

13. The fracturing fluid of claim 12, wherein the copolymer further comprises 2-acrylamido-2-methylpropane sulfonic acid structural units.

14. The fracturing fluid of claim 12, wherein the friction reducer coating further comprises trimethylamino ethyl acrylate structural units.

15. The fracturing fluid of claim 10, wherein the friction reducer coating comprises a binder layer.

16. The fracturing fluid of claim 15, wherein the friction reducer coating comprises (i) the binder layer abutting the outer surfaces of the coke proppant particles, and (ii) a friction reducer coating layer over the binder layer.

17. The fracturing fluid of claim 10, wherein the fracturing fluid further comprises at least one additive, and wherein the at least one additive comprises at least one of an acid, a biocide, a breaker, a corrosion inhibitor, a crosslinker, a gel, a crosslinked gel, an oxygen scavenger, a pH control additive, a scale inhibitor, a surfactant, a weighting agent, an inert solid, a fluid loss control agent, an emulsifier, an emulsion thinner, an emulsion thickener, a viscosifying agent, a foaming agent, a stabilizer, a chelating agent, a mutual solvent, an oxidizer, a reducer, and a clay stabilizing agent.

18. The fracturing fluid of claim 17, wherein the friction reducer coating further comprises at least a portion of the at least one additive.

19. The fracturing fluid of claim 10, wherein at least a portion of the coke proppant particles have a particle size from 210 μm to 860 μm.

20. A method for making friction reducer-coated coke proppant particles, comprising depositing a friction reducer on and/or over outer surfaces of coke proppant particles to obtain friction reducer-coated coke proppant particles; wherein a weight percentage of the friction reducer used during the deposition process is from 0.1 wt % to 2.3 wt %, based on a total weight of the friction reducer and the coke proppant particles; and wherein a thickness of the resulting friction reducer coating is 1 micrometer (μm) to 50 μm.

21. The method of claim 20, wherein the friction reducer comprises a high-viscosity friction reducer (HVFR), and wherein a weight percentage of the friction reducer used during the deposition process is from 0.2 wt % to 1.2 wt %, based on the total weight of the friction reducer and the coke proppant particles.

22. The method of claim 20, wherein the friction reducer-coated coke proppant particles have an apparent density of 1.05 grams per cubic centimeter (g/cm³) to 1.5 g/cm³ when the friction reducer coating is hydrated with water.

23. The method of claim 20, wherein the thickness of the friction reducer coating is 2 μm to 25 μm.

24. The method of claim 20, wherein the friction reducer comprises a copolymer having acrylamide structural units and acrylic acid structural units.

25. The method of claim 24, wherein the copolymer further comprises 2-acrylamido-2-methylpropane sulfonic acid structural units.

26. The method of claim 24, wherein the copolymer further comprises trimethylamino ethyl acrylate structural units.

27. The method of claim 20, wherein the friction reducer coating further comprises a binder, and wherein the method comprises depositing the binder on the outer surface of the coke proppant particles prior to depositing the friction reducer on the outer surface of the coke proppant particles.

28. The method of claim 20, wherein depositing the friction reducer on the outer surface of the coke proppant particles comprises:
spraying a liquid binder onto the coke proppant particles to obtain pre-coated coke proppant particles; and subsequently
mixing the pre-coated coke proppant particles with the friction reducer in a dry powder form.

29. The method of claim 20, wherein depositing the friction reducer on the outer surface of the coke proppant particles comprises:
forming an aqueous solution or slurry of the friction reducer;
mixing the coke proppant particles with the aqueous solution or slurry to obtain wet coke proppant particles; and subsequently
drying the wet coke proppant particles.

30. The method of claim 20, wherein the carrier fluid is substantially free of a friction reducer that is contained in the coated coke proppant particles.

31. The method of claim 20, wherein the coated coke proppant particles comprise a first weight of a friction reducer of W1; wherein the carrier fluid comprises a second weight of the friction reducer of W2; and wherein 10%≤W1/(W1+W2)*100%≤90%.

32. A method for hydraulic fracturing a subterranean formation, comprising introducing the fracturing fluid of claim 10 into the subterranean formation.
